(19) United States
(12) Patent Application Publication
(10) Pub. No.: US 2021/0085064 A1
(43) Pub. Date: Mar. 25, 2021

(54) Tether system and apparatus for handheld devices

(71) Applicant: Harbhajan S. KHALSA, Santa Fe, NM (US)

(72) Inventor: Harbhajan S. KHALSA, Santa Fe, NM (US)

(21) Appl. No.: 16/772,104

(22) PCT Filed: Dec. 21, 2018
(86) PCT No.: PCT/US2018/067155

§ 371 Date: Jun. 11, 2020

Related U.S. Application Data
(60) Provisional application No. 62/633,504, filed on Feb. 21, 2018.
(60) Provisional application No. 62/609,143, filed on Dec. 21, 2017.

(51) Int. Cl. A45F 5/00

(52) U.S. Cl. CPC A45F 5/00; A45F 2005/006; A45F 2200/0508; A45F 2200/0525; A45F 2200/0516

(57) ABSTRACT

A tether system and apparatus is provided for securing a handheld device to a user. The tether apparatus includes a harness having an elastomeric body configured to engage the plurality of corners of the handheld device thereby releasably securing the elastomeric body to the handheld device, a fastener configured for releasably engaging an article worn or borne by a user, and an elongated tether interconnecting the fastener and the harness. A first end of the tether connected to the elastomeric body, and a second end of the tether connected to the fastener. The elastomeric body and the elongated tether may be monolithically formed. The tether apparatus allows a user to easily retrieve the handheld device if dropped.

### BACKGROUND OF INVENTION

### Field of Invention

This application relates, in general, to a tether apparatus for handheld devices and methods for their use. This application also relates, in general, to a tether system for handheld devices and, more particularly, to a tether system for securing handheld devices to a user, as well as methods for their use.

### Description of Related Art

The use of lightweight portable electronic devices such as mobile phones and tablets continues to increase. Users of modern personal electronic devices have come to rely on these devices for many functions. Aside from telephonic and electronic communication, photography is probably the most common use for such devices. In any event, such devices are generally within arm's reach of a user, if not carried within a pocket of the user.

Users carry these devices into various environments, including mountains, construction sites, rivers, lakes, oceans, amusement parks, war zones, search and rescue operations, and many more. Even if a user is carrying such a device within their pocket, the user must remove the device from their pocket to access the device's functionalities. And dropping a personal electronic device in these and other environments can result in several undesirable outcomes for a user. Firstly, the device could be damaged by the fall. Secondly the user could lose the device altogether, for example into water or deep snow. Thirdly the device could injure someone or cause damage to personal property if dropped from a significant height.

Also, users of modern personal electronic devices have come to rely on these devices for many functions. Aside from telephonic and electronic communication, photography is probably the most common use for such devices. Many of these devices are equipped with both front and rear facing cameras that allow the user to engage in a variety of photographic techniques, including snapshots, video journaling, and photographs of one's self (e.g., “selfies”). Because of the importance of the photographic functionality of these devices, it is important that any protective accessory be designed to limit the possibility of interfering with front and rear facing cameras integral to such devices. The challenge only becomes greater when one considers that various smartphone makes and models place their camera lens in different locations on their device.

Further, many users of personal electronic devices employ external cases to adorn, protect or otherwise augment their devices. The additional augmentation that cases can provide include external batteries, external memory storage, camera lenses, water protection, shock protection and more. Such external cases generally increase overall dimensions of the associated device and thus might affect or restrict the compatibility of certain accessories for the associated device.

Some prior art devices have offered some degree of protection. Exemplars of the prior art include U.S. Pat. No. 9,438,299, which describes a stretchable strap cover for an electronic device, and U.S. Pat. No. 9,060,588, which describes a securement apparatus for a portable electronic device.

It would be useful, however, to provide apparatuses that assist users in securing their handheld devices to themselves, their clothing or other personal item, or to a pocket of their clothing or other personal item in a simple and convenient manner regardless of environment or circumstance, while maintaining access to as many as possible of the photographic functions of their handheld devices, regardless of whether the user employs an external case for their device, thereby overcoming the above and other disadvantages.

### BRIEF SUMMARY

One aspect of the present invention is directed to a tether apparatus for securing a handheld device to a user, the handheld device having a plurality of corners, the tether apparatus comprising: a harness including an elastomeric body configured to engage the plurality of corners of the handheld device thereby releasably securing the elastomeric body to the handheld device: a fastener configured for releasably engaging an article worn or borne by a user; and an elongated tether interconnecting the fastener and the harness, a first end of the tether connected to the elastomeric body, and a second end of the tether connected to the fastener: wherein the elastomeric body and the elongated tether are monolithically formed; and wherein the elongated tether allows a user to easily retrieve the handheld device if dropped while the fastener is engaged with the article of the user.

Another aspect of the present invention is directed to a tether apparatus for securing a handheld device to a user, the handheld device having a plurality of corners, the tether apparatus comprising: a harness including an elastomeric web, the web including a plurality of corner apertures, each defining a corner loop configured to stretch over and engage a respective corner of the handheld device thereby releasably securing the harness to the handheld device, the web further including a central opening, wherein the plurality of corner apertures have a maximum aperture dimension and the central opening has a maximum opening dimension, and wherein the maximum opening dimension is larger than the maximum aperture dimension: a fastener configured for releasably engaging an article attached to the user; and an elongated tether interconnecting the fastener and the harness, a first end of the tether being connected to the harness, and a second end of the tether connected to the fastener, wherein the tether allows a user to easily retrieve the handheld device if dropped while the fastener is engaged with the article of the user.

An additional aspect of the present invention is directed to a harness for securing a handheld device to a user, the harness comprising: an elastomeric membrane: a plurality of corner apertures in the membrane, each defining a corner loop configured to stretch over and engage a respective corner of the handheld device thereby releasably securing the harness to the handheld device; and a central opening, wherein a centroid of the membrane is located within the central opening: wherein the harness is configured to connect to a tether that allows the user to easily retrieve the handheld device if dropped while the harness is secured to the handheld device and the tether is engaged with an article of the user.

A further aspect of the present invention is directed to a tether apparatus for securing a handheld device to a user, the handheld device having a plurality of corners, the tether apparatus comprising: an elastomeric harness including a web, the web including a plurality of corner apertures, each defining a corner loop configured to stretch over and engage a respective corner of the handheld device thereby releasably securing the harness to the handheld device: a retractable tether assembly including an elongated tether retractably received within a retractor housing, the retractor housing being located within the elastomeric harness; and a fastener configured for releasably engaging an article attached to the user, the fastener connected to a terminal end of the elongated tether; wherein the elongated tether allows a user to easily retrieve the handheld device if dropped while the fastener is engaged with the article of the user.

Yet another aspect of the present invention is directed to a tether system for securing a handheld device to a user, the handheld device having a plurality of corners, the tether system comprising: a harness including a web configured to releasably engage the handheld device, the web including a plurality of corner apertures, each defining a corner loop configured to stretch over and engage a respective corner of the handheld device thereby releasably securing the harness to the handheld device: an article configured to be worn or borne by a user, the article including a pocket having an interior accessed by an opening, the pocket further comprising a mount secured to the article within the interior of the pocket at a position remote from the opening; and a retractable tether interconnecting the harness and the mount, a first end of the tether being connected to the harness, and a second end of the tether connected to the mount.

The tether apparatus and tether system may further include one or more of the following features, any of which may be utilized with any of the above described tether apparatuses and systems. The elastomeric web may be formed of silicone, latex or rubber. The elastomeric body may include a plurality of corner apertures, each defining a corner loop configured to stretch over and engage a respective corner of the handheld device thereby releasably securing the harness to the handheld device. The elastomeric body may include a solid region having a receptacle receiving a medallion therein, the medallion may have ornamental indicia. An RFID chip may be mounted within the receptacle. The elastomeric body may include a central opening, wherein a centroid of the body may be located within the central opening. The tether may be retractable having a first retracted length in a retracted mode, and a second extended length in an extended mode, wherein the second extended length may be configured to prevent the handheld device from dropping to the ground when the fastener is secured to the article of the user. The tether may include a plurality of bends, wherein the bends flex and straighten when the tether is pulled. The tether may be flat. The second end of the tether may include a loop for releasably securing the tether to the fastener with a girth hitch. The handheld device may be a rectilinear personal electronic device, and the web may include four corner apertures defining four respective corner loops, each configured to stretch over and engage a respective corner of the personal electronic device. The personal electronic device may include a centrally-located rear-facing camera, and wherein the central opening may be configured to provide unobstructed access to the rear-facing camera while the harness is secured to the personal electronic device.

The elastomeric body may include a plurality of corner apertures, each defining a corner loop configured to stretch over and engage a respective corner of the handheld device thereby releasably securing the harness to the handheld device, the elastomeric body further including a central opening, wherein the plurality of corner apertures have a maximum aperture dimension and the central opening has a maximum opening dimension, and wherein the maximum opening dimension may be larger than the maximum aperture dimension. The elastomeric body may include a plurality of corner apertures in the body, each defining a corner loop configured to stretch over and engage a respective corner of the handheld device thereby releasably securing the harness to the handheld device, and the body may have a central opening, wherein a centroid of the membrane may be located within the central opening. The elastomeric body may include a plurality of corner apertures, each defining a corner loop configured to stretch over and engage a respective corner of the handheld device thereby releasably securing the harness to the handheld device, and wherein the elongated tether may be retractably received within a retractor housing, the retractor housing being located within the elastomeric body, and wherein the fastener may be connected to a terminal end of the elongated tether, wherein the elongated tether allows a user to easily retrieve the handheld device if dropped while the fastener is engaged with the article of the user. The elastomeric body may be monolithically formed in situ about the retractor housing.

The tether apparatus may further include an article configured to be worn or borne by a user, the article including a pocket having an interior accessed by an opening, the pocket may include a mount secured to the article within the interior of the pocket at a position remote from the opening, wherein the elongated tether is retractable and interconnects the harness and the mount, a first end of the tether being connected to the harness, and a second end of the tether connected to the mount. The pocket may include a perimeter, and the mount may be secured to the article along the perimeter remote from the opening. The perimeter may include a corner remote from the opening, wherein the mount may be secured to the article at the corner. The mount may be secured to the article along the perimeter, and wherein the mount may be one of a loop or a D-ring. The web further may include a mounting hole therethrough for mounting the first end of the tether to the harness. The central opening may be located at the center of mass of the web. The central opening may be asymmetric.

The article attached to the user may be clothing worn by the user or a personal item carried by the user. The first end of the tether may be permanently attached to the harness. A retractable tether assembly may include a retractor housing, wherein the harness may include a chamber encasing the retractor housing, wherein the harness may be monolithically formed about the retractor housing. The elastomeric harness may include a chamber encasing the retractor housing, and a tether passage extending from the chamber allowing the elongated tether to retract through the elastomeric harness and into the retractor housing. The retractor housing may be permanently mounted within the chamber of the elastomeric harness. The elongated tether may pass through a tube, wherein the tube prevents rubbing between the elongated tether and the tether passage of the elastomeric harness. The article may be selected from the group consisting of a jacket, a vest, a shirt, a pair of pants, a jacket, a vest, a backpack, a courier bag, a hand bag, a purse, luggage, work bag, childcare bag, and a briefcase. The opening may be defined by a zipper. The tether may include a retractable lanyard having a cord retractably mounted on a retractor intermediate the first and second ends of the tether. The tether may include a cord having a coiled section extending intermediate the first and second ends of the tether.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a front view of an exemplary tether apparatus for handheld devices in accordance with various aspects of the present invention, the tether apparatus mounted on a mobile phone having a corner-mounted rear-facing camera.

FIG. 2 is a rear view of the tether apparatus of FIG. 1 mounted on a mobile phone as shown in FIG. 1.

FIG. 3 is a side view of the tether apparatus of FIG. 1 mounted on a mobile phone as shown in FIG. 1.

FIG. 4 is a front view of the tether apparatus of FIG. 1, the tether apparatus in its unmounted state in accordance with various aspects of the present invention.

FIG. 5 is a side view of the tether apparatus of FIG. 1, the tether apparatus in its unmounted state as shown in FIG. 4.

FIG. 6 is a front view of the tether apparatus of FIG. 1 mounted on another mobile phone having a centrally-mounted rear-facing camera in accordance with various aspects of the present invention.

FIG. 7 is a rear view of the tether apparatus of FIG. 1 mounted on another mobile phone as shown in

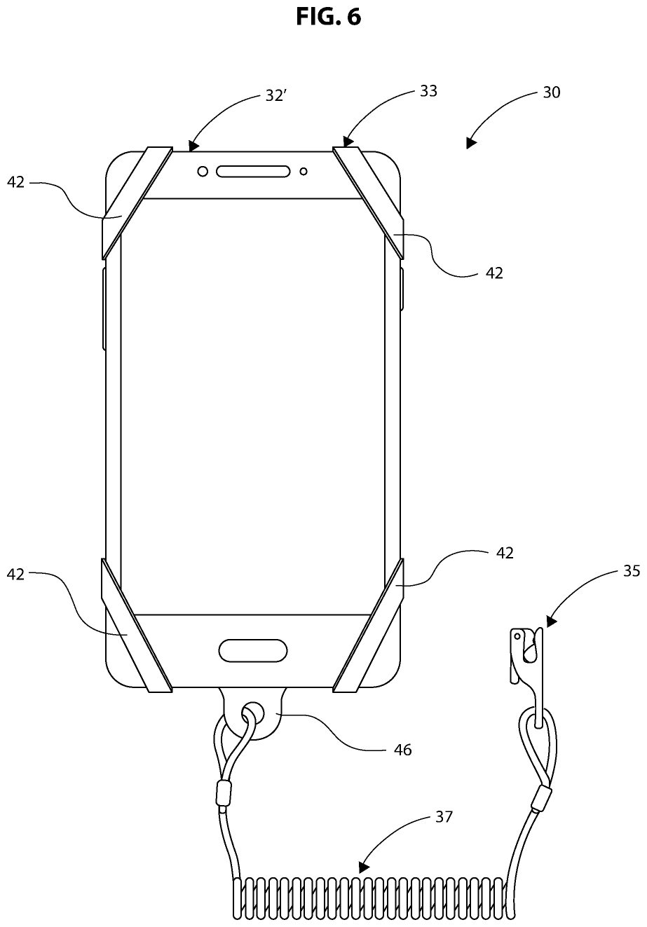

FIG. 6.

FIG. 8 is a rear view of another tether apparatus in its unmounted state in accordance with various aspects of the present invention.

FIG. 9 is a side view of the tether apparatus of FIG. 8, including a partial cross-section taken along line 9-9 in FIG. 8.

FIG. 10 is a rear view of another tether apparatus in its unmounted state in accordance with various aspects of the present invention.

FIG. 11 is a side view of the tether apparatus of FIG. 10.

FIG. 12 is a front view of another tether apparatus in its unmounted state in accordance with various aspects of the present invention.

FIG. 13 is a front view of another tether apparatus in its unmounted state in accordance with various aspects of the present invention.

FIG. 14 is a front view of another tether apparatus in its unmounted state in accordance with various aspects of the present invention.

FIG. 15 is a front view of another tether apparatus in its unmounted state in accordance with various aspects of the present invention.

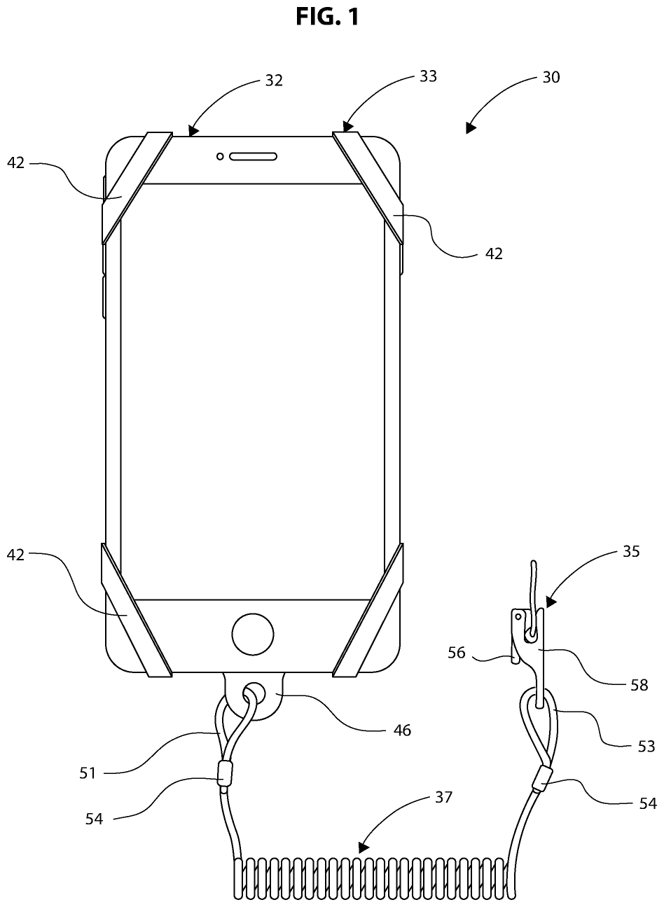

FIG. 16 is a front view of the tether apparatus of FIG. 1 mounted on the mobile phone of FIG. 6 in an external case in accordance with various aspects of the present invention.

FIG. 17 is a rear view of the tether apparatus of FIG. 1 mounted on another mobile phone as shown in

FIG. 16.

FIG. 18 is a rear view of another tether apparatus in its unmounted state in accordance with various aspects of the present invention.

FIG. 19A is a side view of the tether apparatus of FIG. 18 including a partial cross-section taken along line 19-19, and FIG. 19B is an enlarged detail thereof.

FIG. 20A is a rear view of another tether apparatus in accordance with various aspects of the present invention having a monolithic harness and tether, FIG. 20B showing the tether attached to a fastener with a girth hitch, and FIG. 20C being a side view of FIG. 20B.

FIG. 21A is a rear view of another tether apparatus similar to that shown in FIG. 20A but having a fastener having a hanger allowing the harness to hang from the fastener as shown in FIG. 21B, with FIG. 21C being an enlarged view of the fastener shown in FIG. 21B.

FIG. 22A is a front view of another tether apparatus in its unmounted state in accordance with various aspects of the present invention, and FIG. 22B is a side view thereof.

FIG. 23 is a view of an exemplary tether system incorporating the apparatus of FIG. 1 in accordance with various aspects of the present invention, the tether system securing a handheld device to a pocket of an article of clothing worn by a user.

FIG. 24 is an enlarged view of the tether system, handheld device and pocket of FIG. 23.

FIG. 25 is another enlarged view of the tether system, handheld device and pocket of FIG. 23 showing hidden details of the tether system and handheld device within the pocket.

FIG. 26 is a view of another exemplary tether system in accordance with various aspects of the present invention, the tether system securing a handheld device to a pocket of a personal item carried by a user.

FIG. 27 is another enlarged view of the tether system in accordance with various aspects of the present invention, the view showing hidden details of the tether system and handheld device within the pocket.

FIG. 28 is an enlarged view of another tether system in accordance with various aspects of the present invention, the tether system securing a handheld device to a pocket of a user.

FIG. 29 is an enlarged view of another tether system in accordance with various aspects of the present invention, the tether system securing a handheld device to a pocket of a user.

FIG. 30 is a view of another exemplary tether system in accordance with various aspects of the present invention similar to that shown in FIG. 1, the tether system having a harness configured to receive indicia.

FIG. 31 is a side view of the harness and retractable tether of the tether system of FIG. 30.

FIG. 32 is a view of another exemplary tether system in accordance with various aspects of the present invention similar to that shown in FIG. 1, the tether system having a harness configured to receive indicia.

FIG. 33 is a side view of the harness and retractable tether of the tether system of FIG. 32.

FIG. 34 is a view of another exemplary tether system in accordance with various aspects of the present invention similar to that shown in FIG. 1, the tether system having a harness configured to receive indicia.

FIG. 35 is a side view of the harness and retractable tether of the tether system of FIG. 34.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

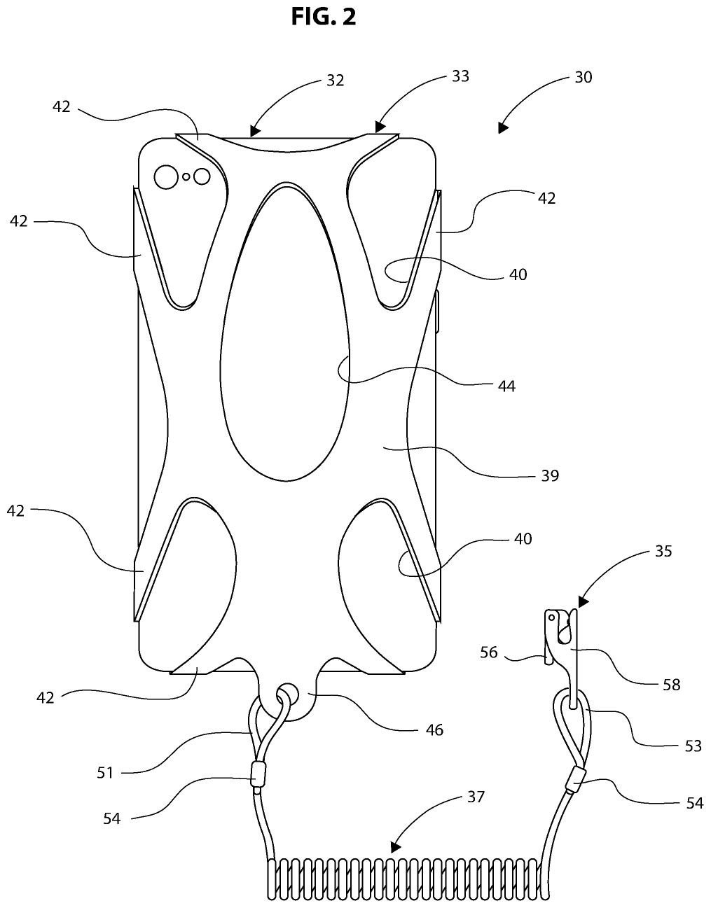

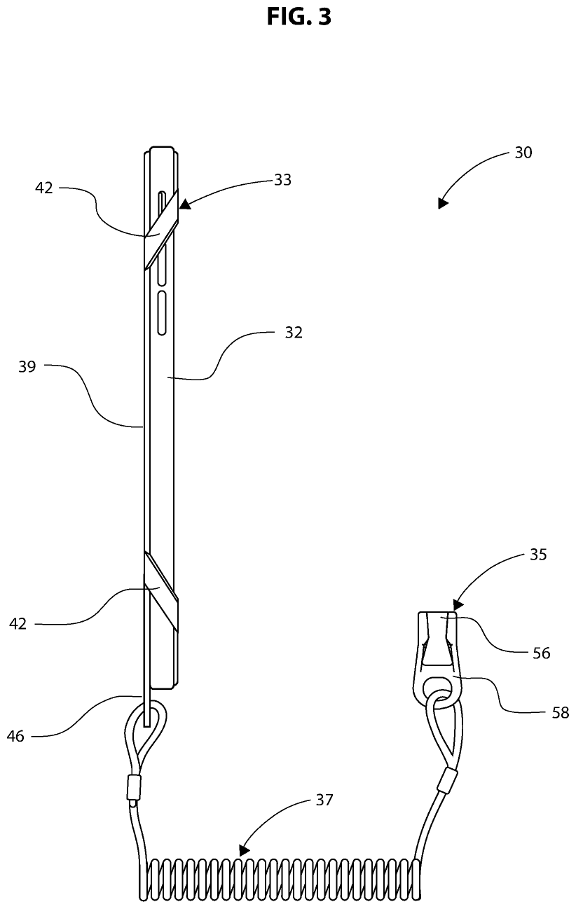

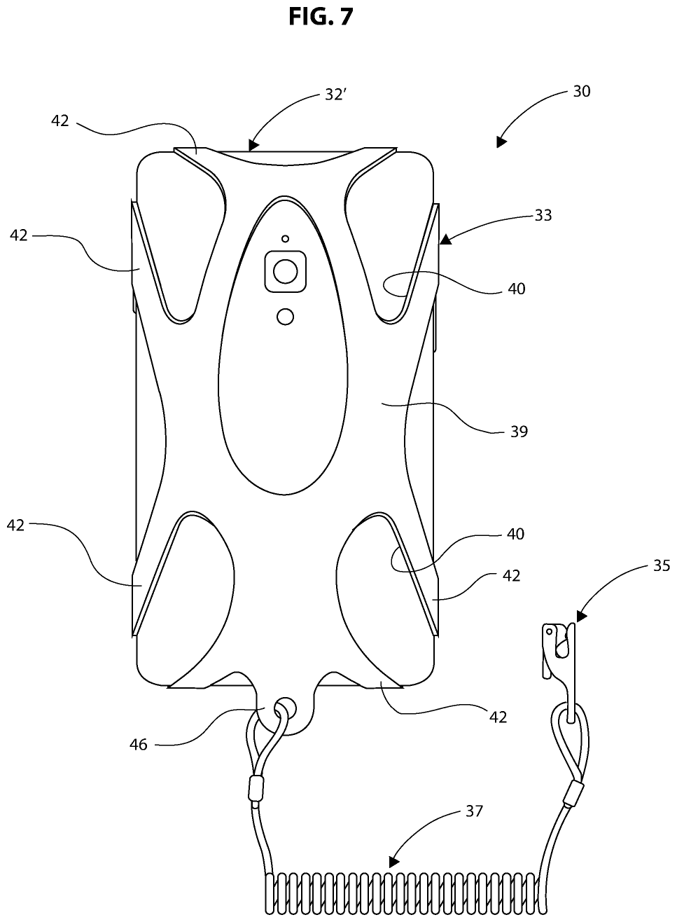

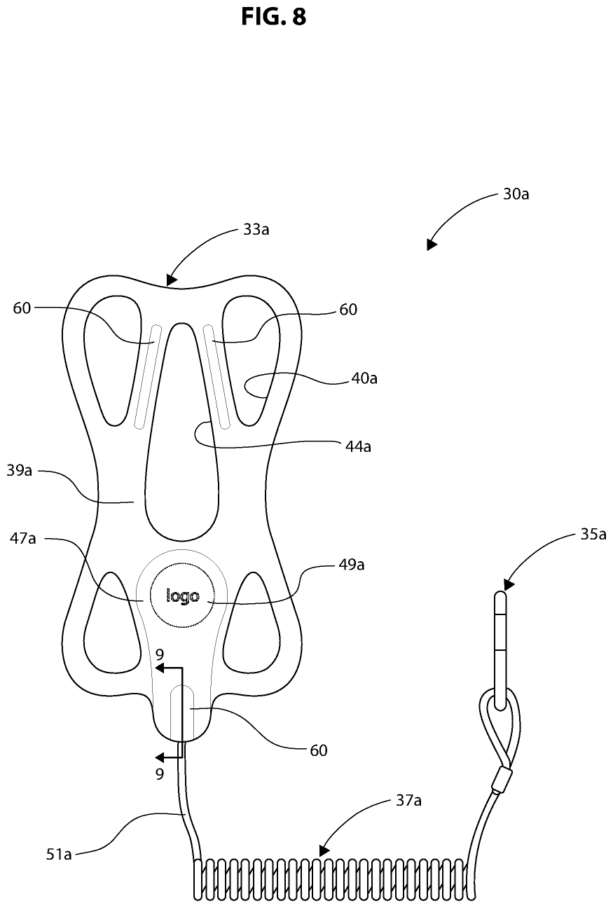

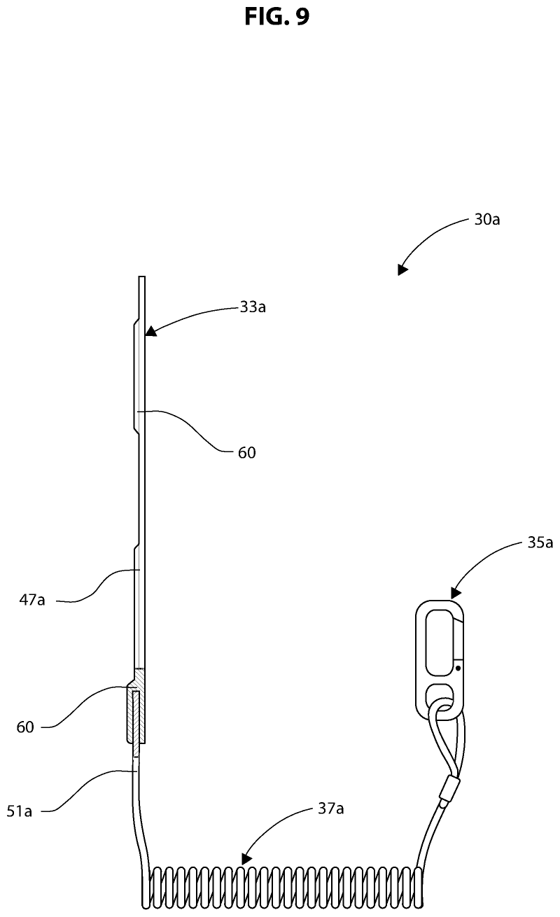

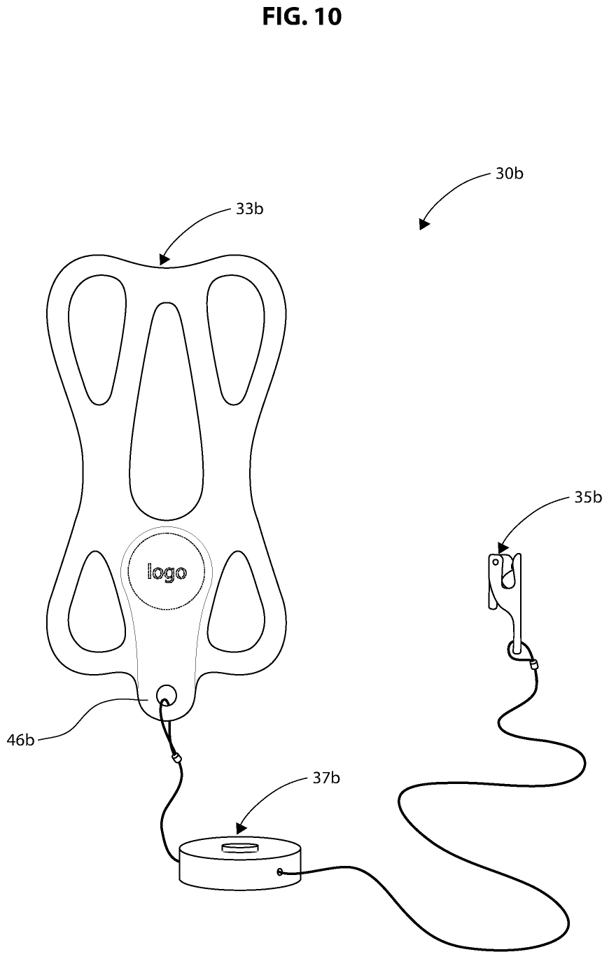

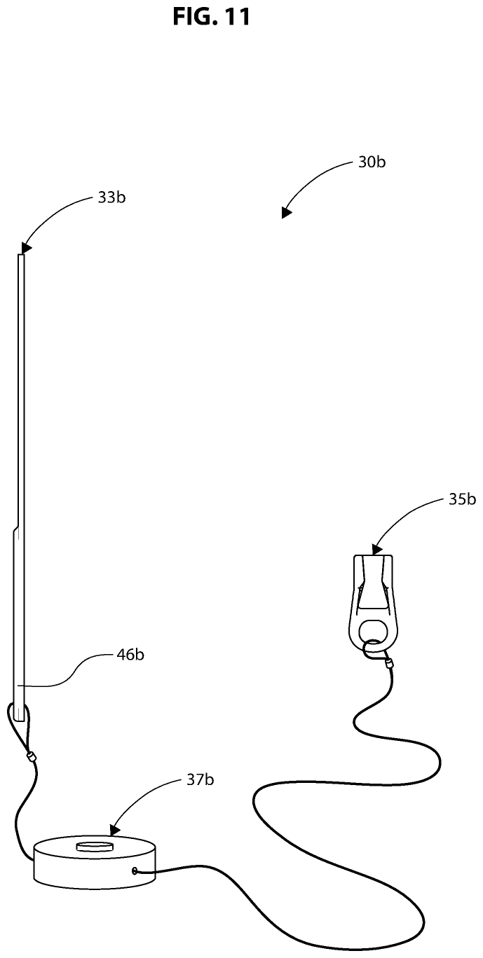

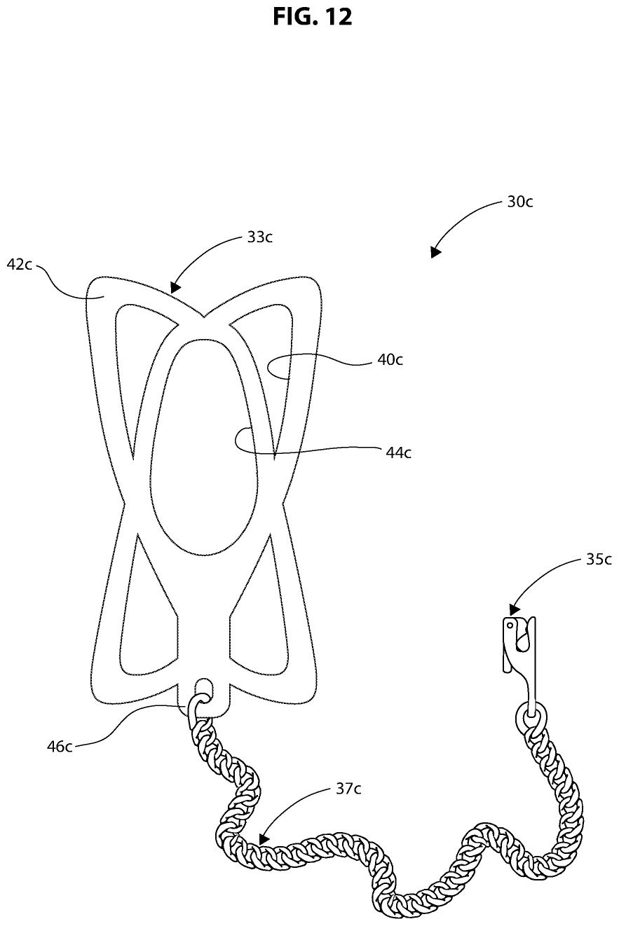

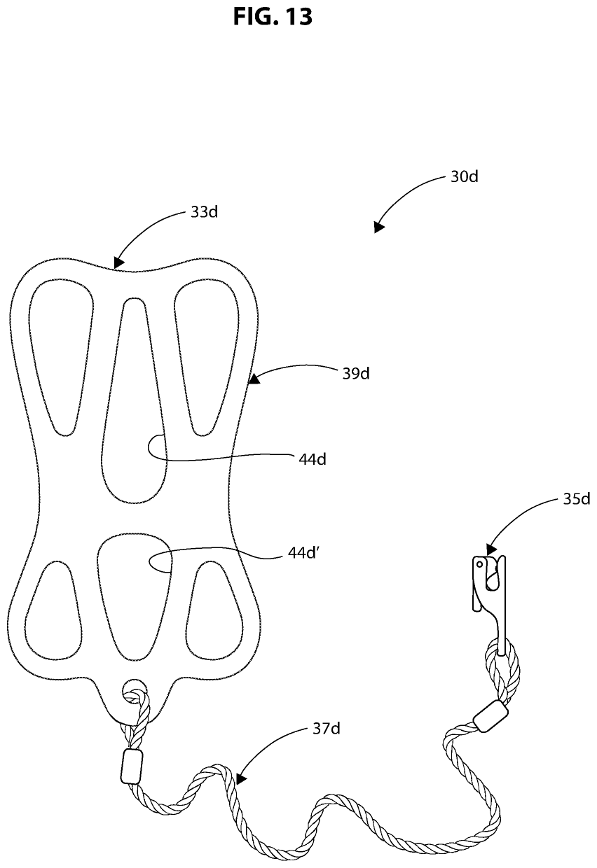

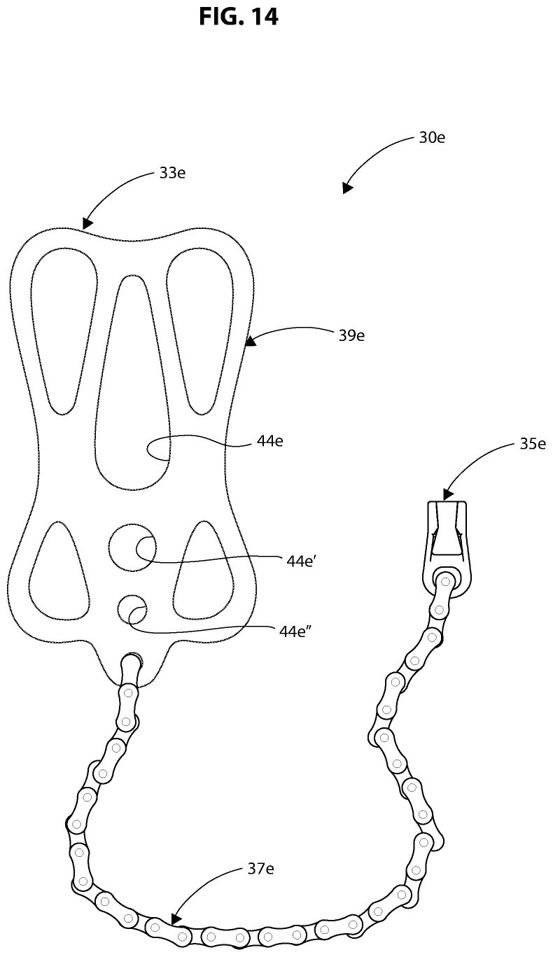

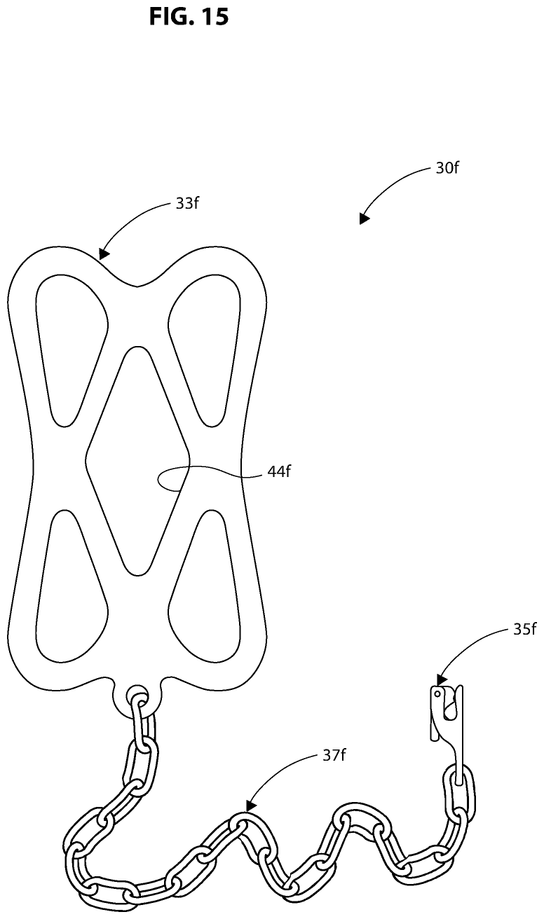

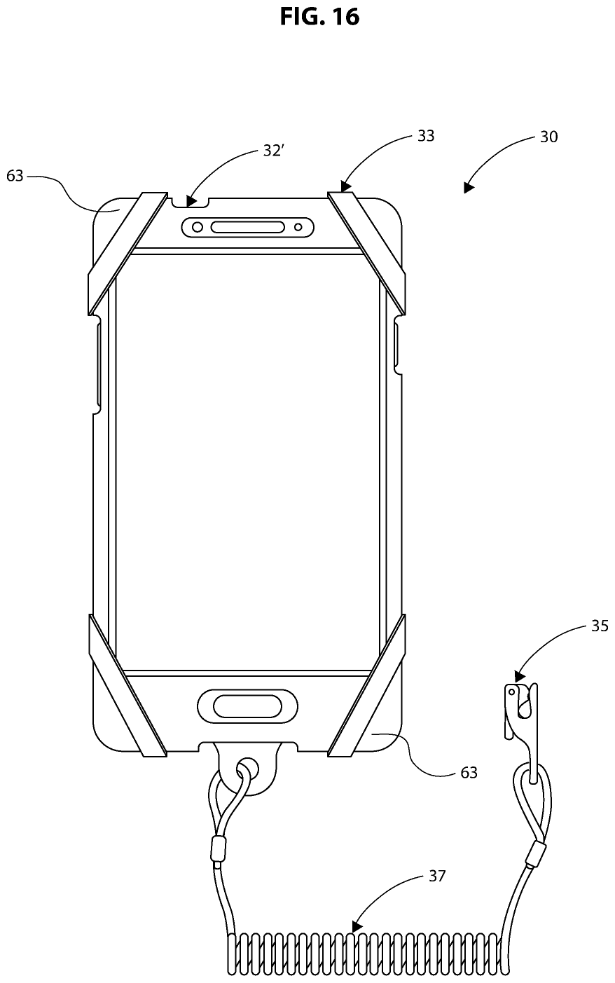

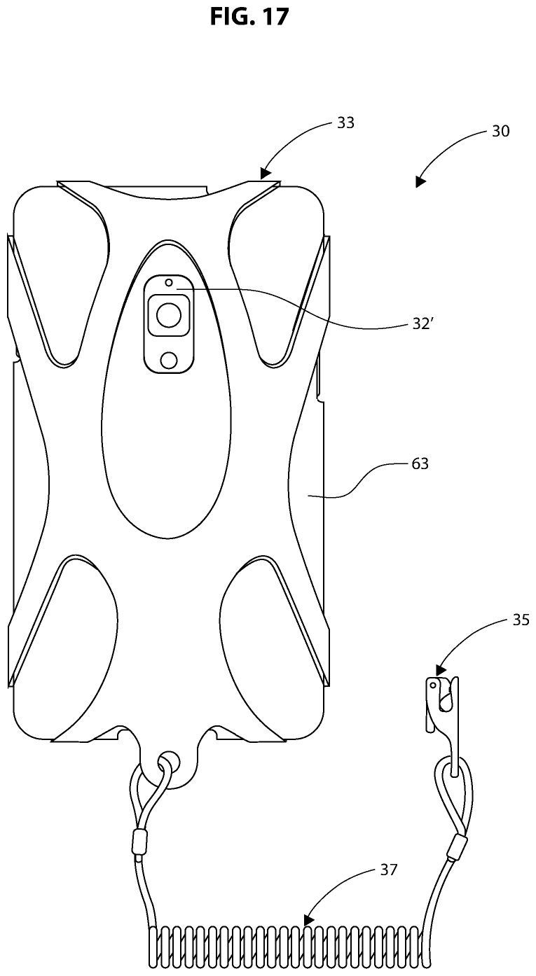

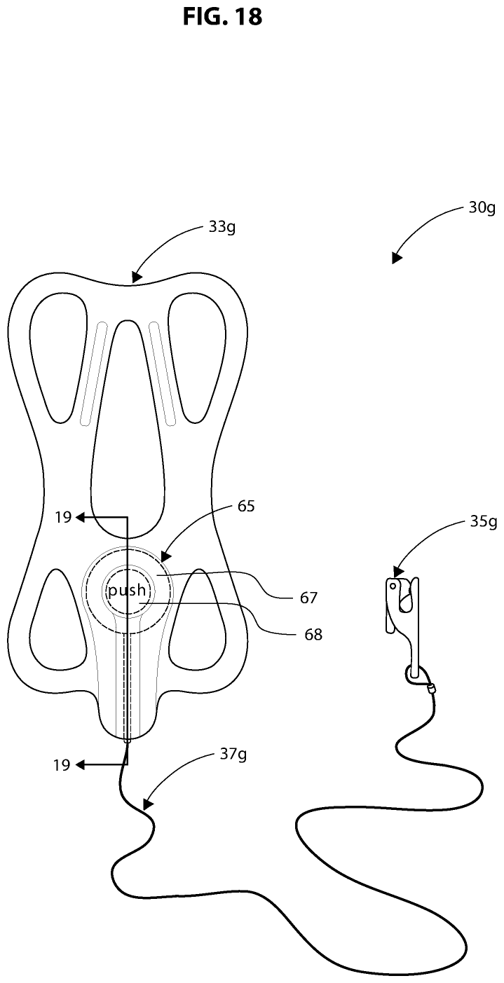

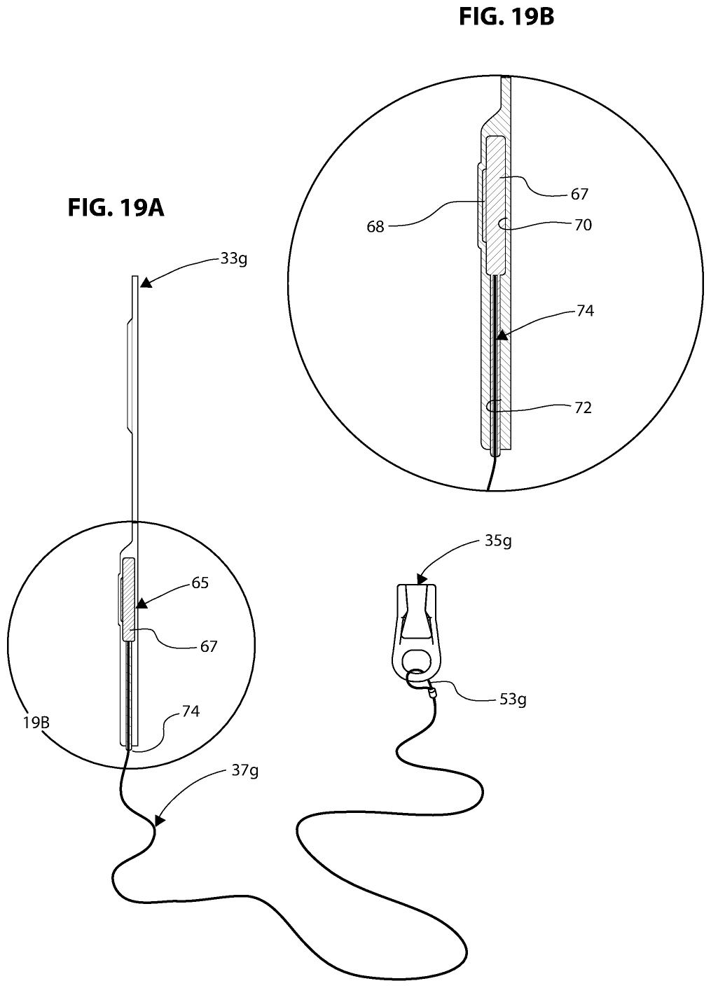

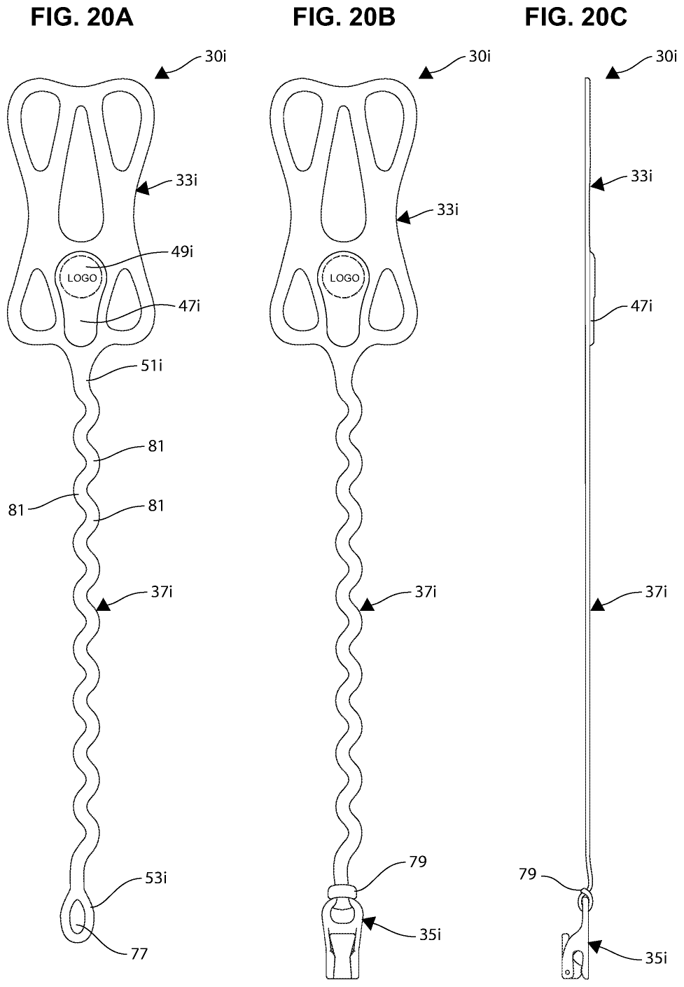

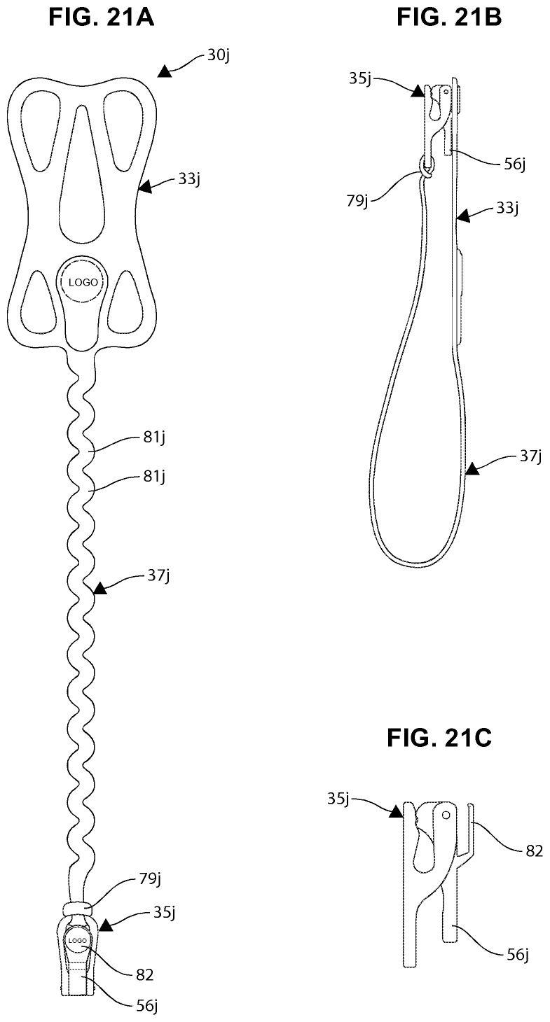

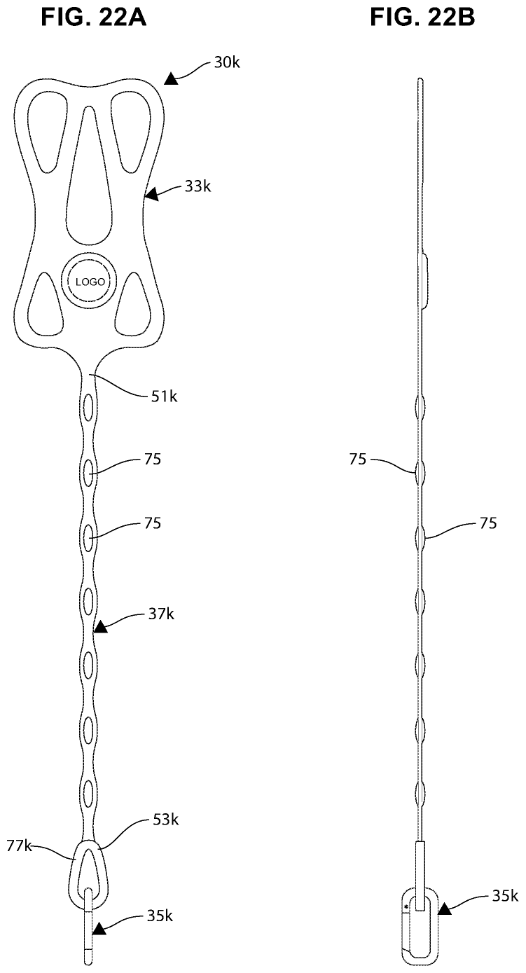

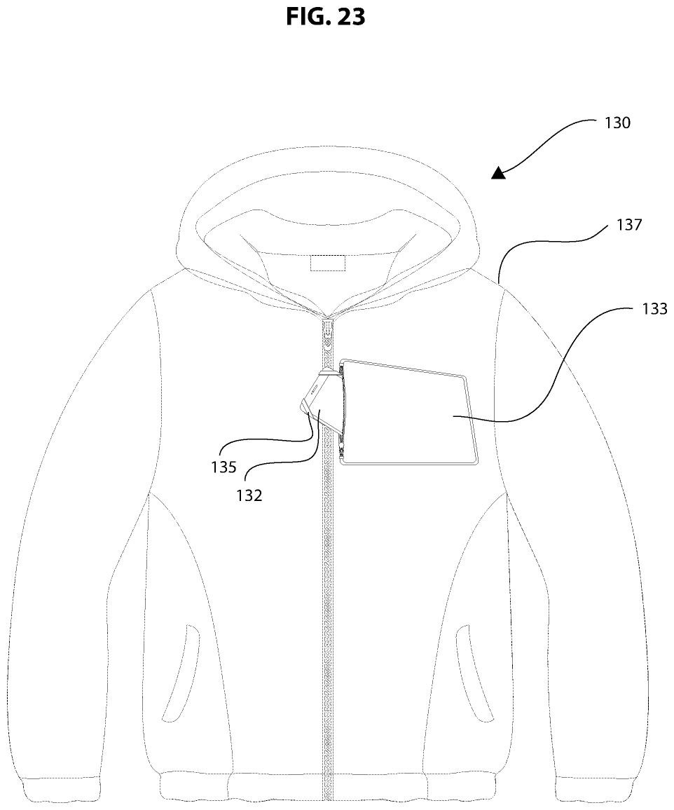

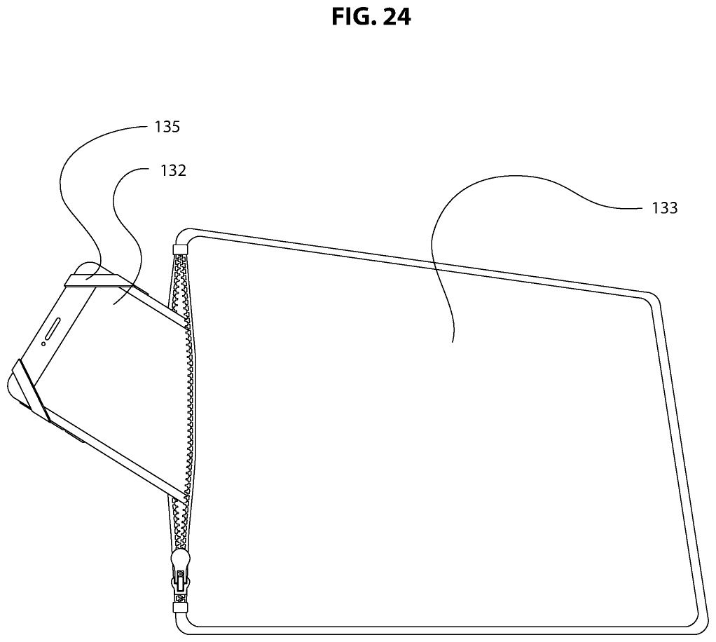

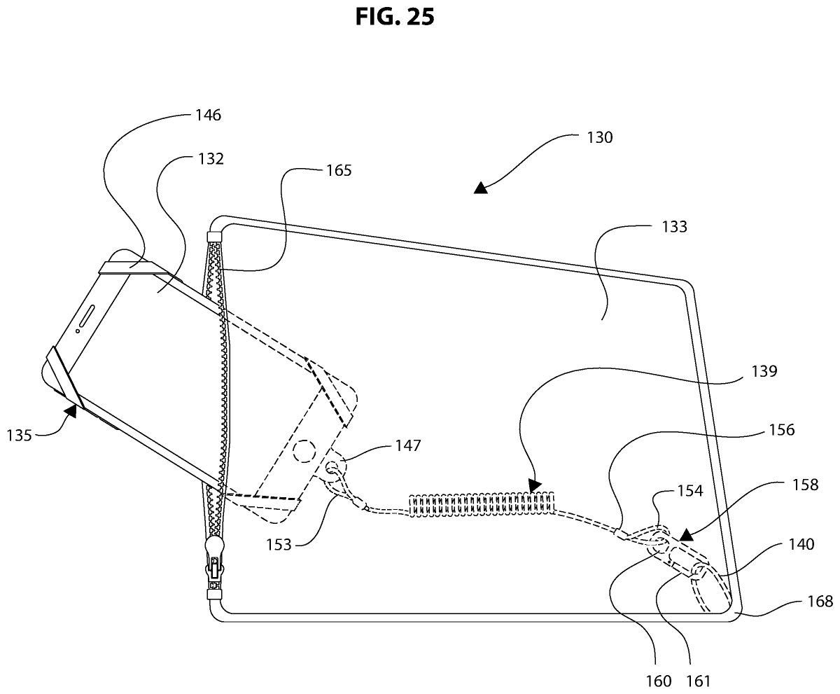

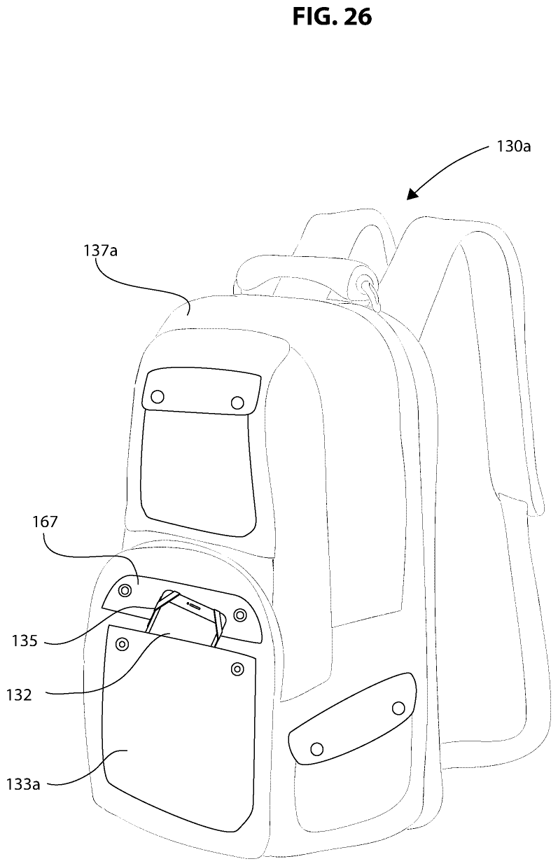

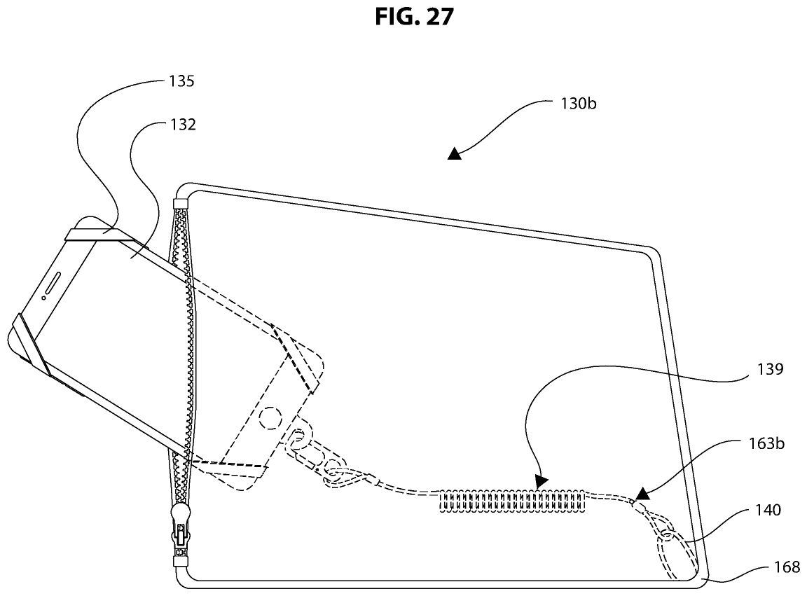

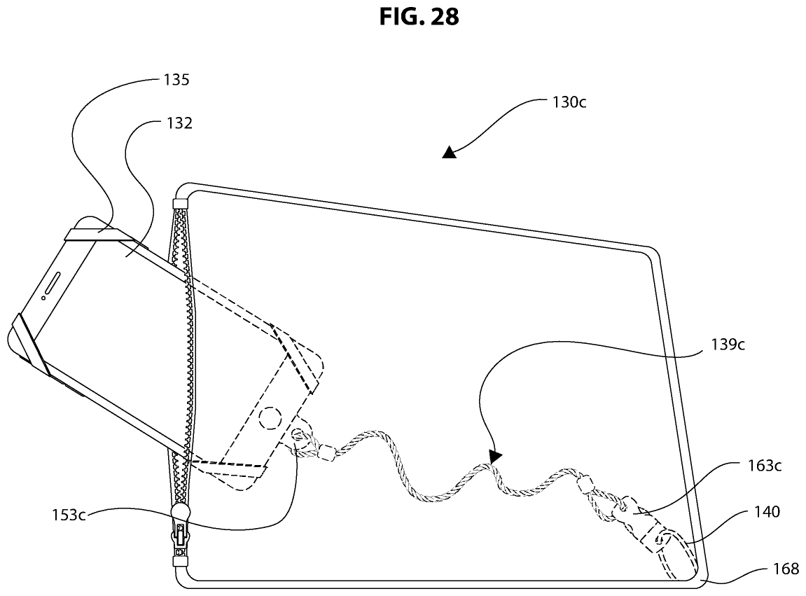

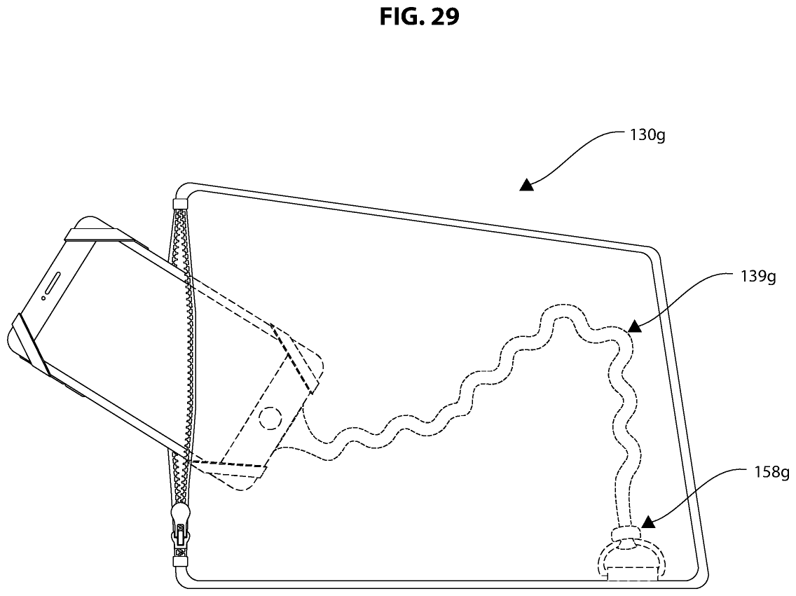

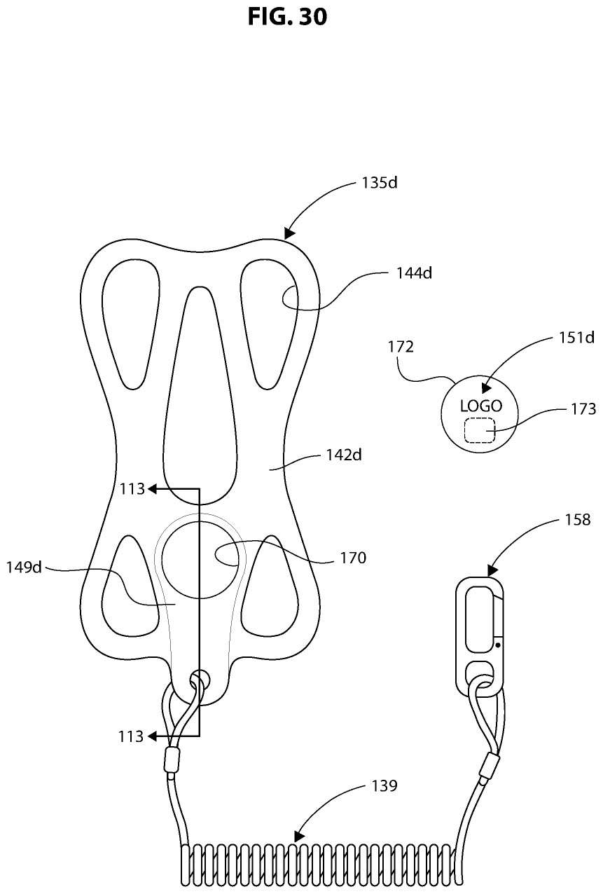

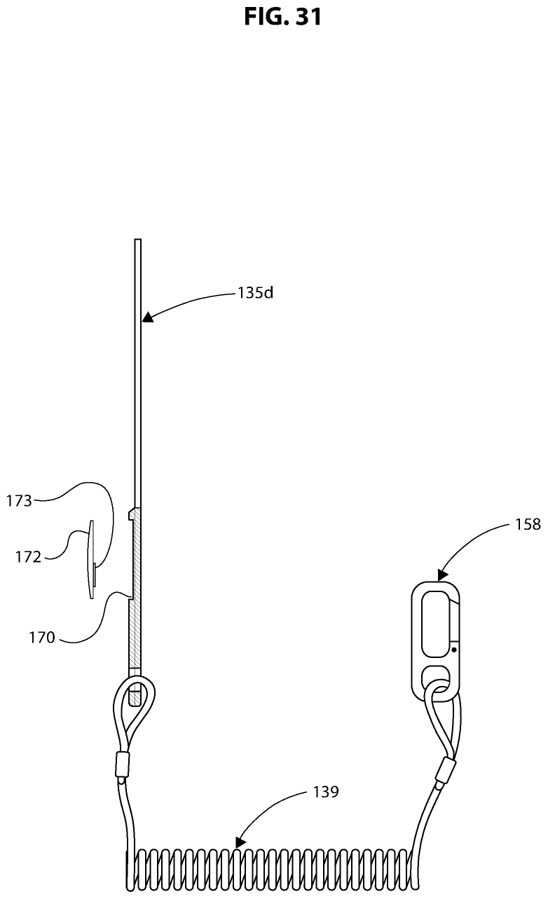

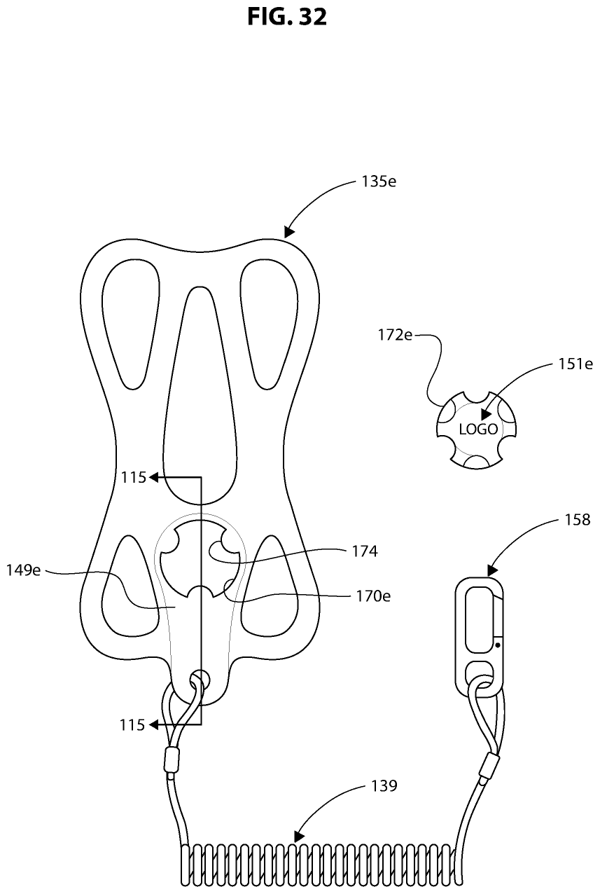

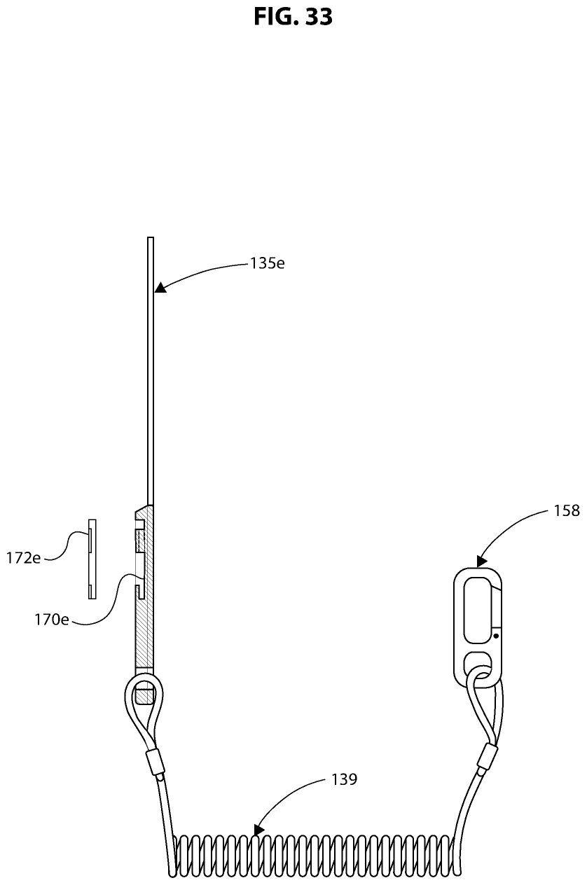

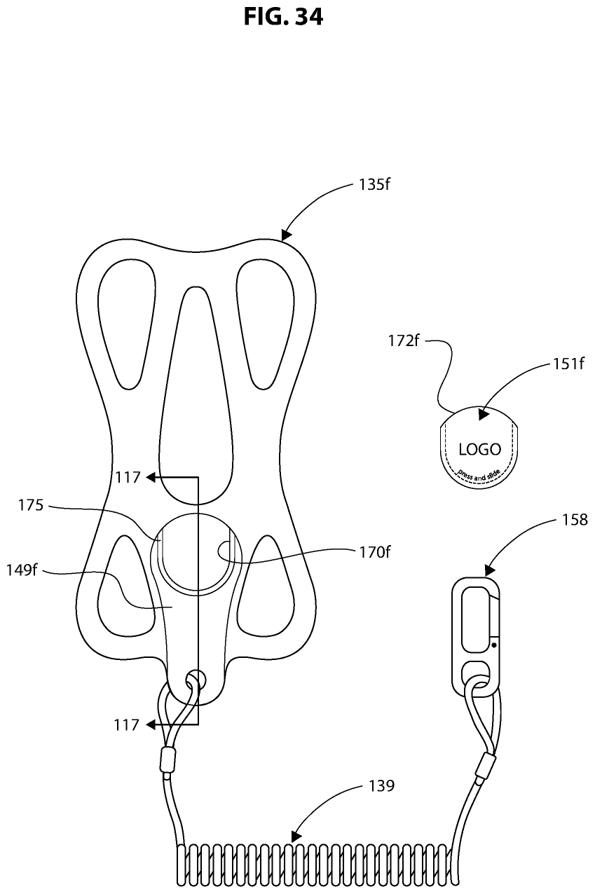

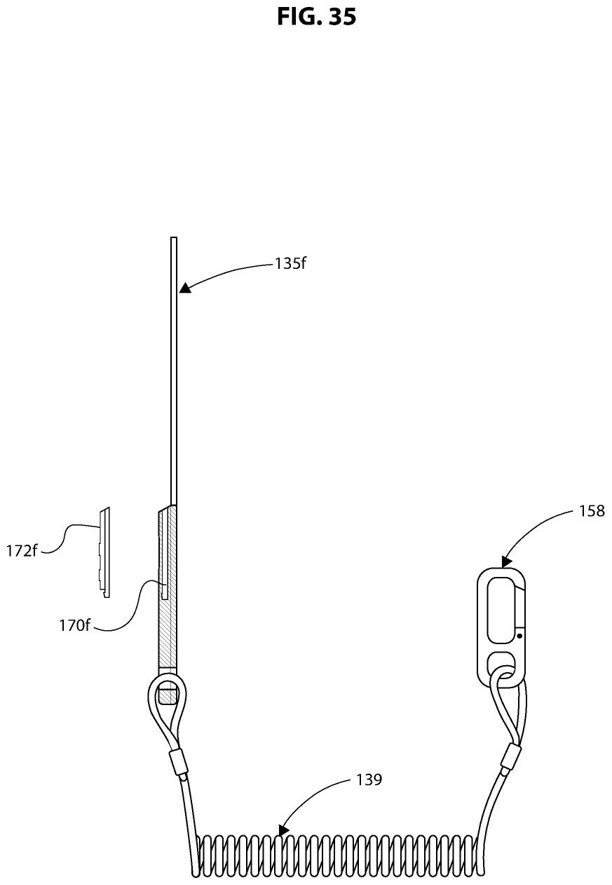

Turning now to the drawings, wherein like components are designated by like reference numerals throughout the various figures, attention is directed first to FIG. 1, which illustrates an exemplary a tether apparatus, generally designated 30, mounted on a handheld device 32 in the form of a mobile phone such as an iPhone 8 (trademark of Apple, Inc.) mobile phone that has a corner-mounted rear-facing camera as shown in FIG. 2, and then to FIG. 6, which illustrates the same tether apparatus 30 mounted on another handheld device 32′ in the form of a mobile phone having a centrally-mounted rear-facing camera such as an Android (trademark of Google, Inc.) mobile phone or a Galaxy 8 (trademark of Samsung Electronics Co., Ltd.) mobile phone as shown in FIG. 7, in accordance with various aspects of the present invention.

Generally, tether apparatus 30 includes a harness 33, a fastener 35, and a tether 37 interconnecting the two. The harness is configured to stretch over and engage the respective corners of a handheld device, while the fastener is configured for releasably engaging an article attached to a user, such as clothing worn by the user or a personal item carried by the user. The tether interconnects the fastener and the harness whereby the tether prevents the handheld device from dropping far and allows a user to easily retrieve the handheld device if dropped while the fastener is engaged to the user's clothing or personal item.

In accordance with various aspects of the present invention, the tether apparatus of the present invention may be configured for use with various handheld devices that a user might carry on their person, including but not limited to personal or portable electronic devices such as smartphones and other mobile phones, tablets, e-readers, digital cameras, MP3 players, electronic toys, personal digital assistants, laptop computers and the like. In accordance with various aspects of the present invention, the harness is dimensioned and configured to releasably attach to various handheld devices, preferably being compatible with a wide variety of smartphones such that it allows a user unobstructed access and use of any front and/or rear facing cameras integral to the device.

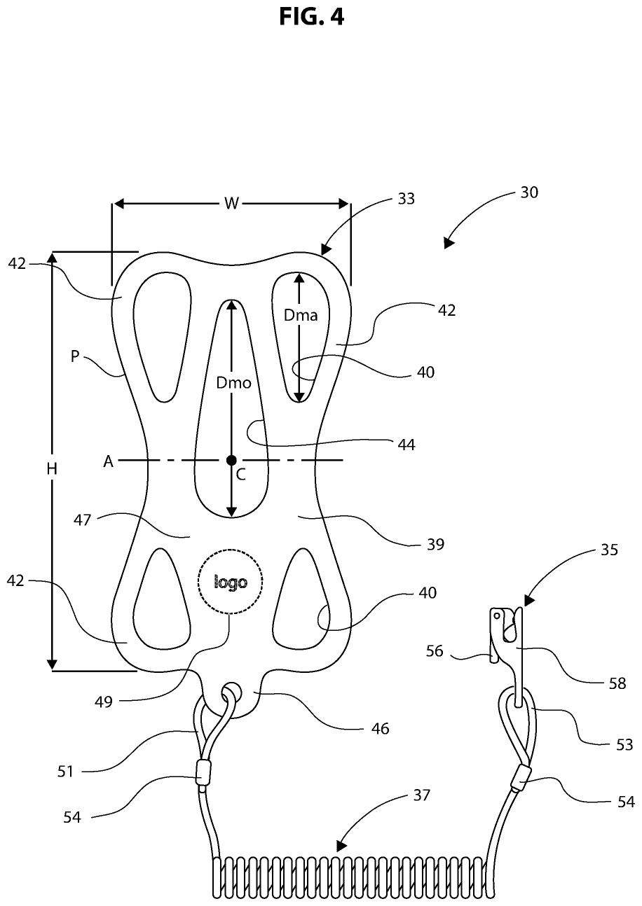

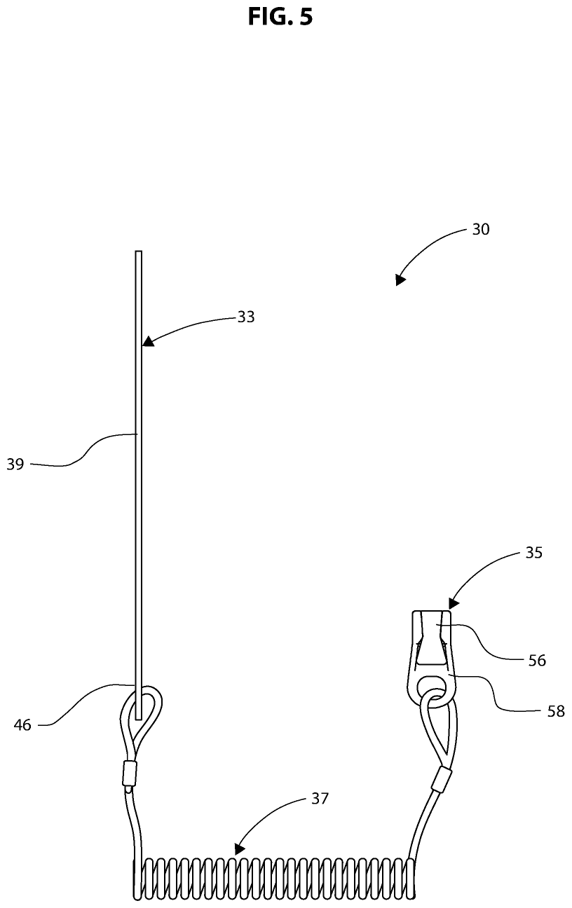

With reference to FIG. 4, harness 33 is generally formed of an elastomeric membrane or web 39. The web includes a plurality of corner apertures 40 that each define a corner loop 42 configured to stretch over and engage a respective corner of the handheld device to releasably secure the harness to the handheld device. The web further includes at least a central opening 44 that is configured to provide unobstructed access and use of centrally-located rear-facing cameras.

While the present invention has been described to allow unobstructed access to and use of cameras, one will appreciate that various handheld devices may have other hardware components that would likewise benefit from unobstructed access. For example, central opening 44 may allow unobstructed access to buttons, fingerprint scanners, flashes and other components that may be located on the rear side of a handheld device.

In various embodiments the web may include a peripheral tab 46 for mounting the tether to the harness. The web may also include a solid region 47 between the central opening and the tab that may strengthen the tab and also provide space for the provision of some indicia 49 such as a logo or other graphic, as shown in FIG. 4. In various embodiments, the indicia may include an RFID chip that is implanted or otherwise located within the solid region.

The web is formed of a polymer, preferably an elastomer that readily allows each corner loop to be stretched over a respective corner of the handheld device to thereby engage harness 33 to handheld device 32 (see, e.g., FIG. 1). The web may be formed of silicone, rubber, neoprene, rubber, latex, urethane, and/or other suitable materials that provide the corner loops and overall web with sufficient elasticity to stretch over and engage the corners of a handheld device. In various embodiments, the web is formed from an elastomeric sheet, in which the peripheral shape, corner apertures and central opening are cut from the sheet. One will appreciate that the web may be cut from an elastomeric sheet by stamping, laser cutting, waterjet cutting, or other suitable means. In other embodiments the web may be molded, cast, 3D printed, and/or manufactured by other suitable means.

In various embodiments, the membrane or web is of substantially uniform thickness in the range of 0.5 mm to 3.5 mm, preferably in the range of 1.0 to 3.0 mm, and more preferably in the range of 1.5 to 2.5 mm. As the web has a generally uniform thickness, the corner loops have a generally elongated rectangular cross-section, which shape is particularly well suited for engaging the corner of a handheld device. In contrast to a circular cross-section that may “roll off” the corner with relative ease, the rectangular and/or elongated cross-section in combination with the tension of corner loop 42 while stretched over a corner of the handheld device will reduce the possibility of the corner loop from rolling of the edges of the handheld device.

In addition, the web is dimensioned and configured to have sufficient stretch or flexibility to allow each corner loop be stretched over a respective corner of the handheld device regardless of whether or not a close-fitting external case is mounted on the device. For example, Apple, Inc., the manufacturer of iPhone mobile phones, offers silicone, leather, wood, and other cases that largely surround the sides and back of respective mobile phones (see, e.g., https://www.apple.com/shop/iphone/iphone-accessories/cases-protection). While some cases are generally close fitting, and other cases bulkier, such cases generally add to overall height, width and thickness. Accordingly, the web is preferably dimensioned and configured to have sufficient stretch or flexibility to allow each corner loop be stretched, not only over a respective corner of a mobile phone, but also over the respective corner of a case mounted to the mobile phone.

Many handheld devices are generally rectilinear. Accordingly, harness 33 includes four corner apertures and corner loops, with each loop being configured to stretch over and engage a respective corner of the rectilinear device. One will appreciate that other handheld devices may have other shapes, with three, four or more corners. Accordingly, one will appreciate that the harness may have other geometric shapes with a number of corners that correspond to the respective handheld devices. One will also appreciate that the harness need not have a corner aperture and corner loop that corresponds with all of the corners of a respective device. For example, in the case of a rectangular smartphone, one will appreciate that a triangular harness might be configured to have three corner apertures and loops that are configured to stretch over and engage three of the four corners of the smartphone to provide engagement of the triangular harness to a rectangular smartphone.

As noted above, central opening 44 is configured to provide unobstructed access and use of centrally-located rear-facing cameras. In various embodiments, the central opening is located at the centroid C of the web, as shown in FIG. 4. As the web is monolithically formed, the web generally has a substantially uniform material density, and thus the centroid of the web is generally concentric with the center of gravity of the web. In various embodiments, the central opening may be formed such that it has a maximum opening dimension (e.g., D_{MA}) larger than the maximum aperture dimension (e.g., D_{MO}) of any of the corner apertures 40, as shown in FIG. 4, which configuration allows unobstructed access and use of centrally-located rear-facing cameras.

The central opening may be elongated and asymmetric about a horizontal axis A, as shown in FIG. 4, which configuration is also particularly suited for use with mobile phones have a centrally-located rear-facing camera of the type shown in FIG. 7. One will appreciate, however, that the shape of the central opening may vary. For example, the central opening may be egg-shaped, circular, oval, oblong, or of other suitable shapes. In various embodiments, the perimeter of the central opening is free of sharp corners so as to avoid stress points at which the web might tear.

In various embodiments, the area defined by the outer perimeter (e.g., P in FIG. 4) of the web would be of similar proportions but smaller than the area defined by the general shape of the handheld device. Similarly, the overall height and width dimensions of the web, not including the tab, would be smaller than the overall height and width dimensions of the handheld device. Preferably, the overall height and width dimensions of the web are at least approximately 10% smaller than those of the handheld device, preferably at least approximately 15% smaller, and more preferably at least approximately 20% smaller. For example, in the case of a personal electronic device having generally rectangular shape with a height of 138 mm and a width of 67 mm (e.g., an iPhone 8 mobile phone), a web having a height of 110 mm and a width of 54 mm would be particularly well suited to allow the corner loops to stretch over and engage the respective corners of the personal electronic device. One will also appreciate that the same web may be used to engage other similarly sized phones but having a slightly larger height, for example one having a height of 149 mm and a width of 68 mm (e.g., a Galaxy S8 mobile phone). And if the personal electronic device has an external case mounted thereon, such dimensions of the web are also suitable to allow the corner loops of the web be stretched over and engage the corners of both the personal electronic device and its external case mounted thereon.

With reference to FIG. 4, tab 46 extends downwardly from web 39 generally between the lower two corner apertures 40. In various embodiments, the tab includes a hole designed to receive an end of tether 37. In other embodiments, the web may be monolithically formed with and/or integrally attached to the tether. For example, the tether may be molded with the web and harness of the same material and of unitary construction, such as that shown in FIG. 20A. Alternatively, the tab and/or harness may be overmolded around the tether to form a strong permanent connection between the tab and tether, as shown in FIG. 9.

Tether 37 includes a first end 51 connected to tab 46 and a second end 53 connected to fastener 35. In various embodiments, the tether is retractable with first and second ends in the form of closed loops that are closed. The loops may be mechanically formed (e.g., by a crimp 54, by stamping, etc.), however, the loops may be formed by other means such as monolithically formed with the tether, thermally formed (e.g., folding an end back and heat welding the end to the tether), or chemically formed (e.g., folding an end back and chemically bonding the end to the tether), or formed by other suitable means. One will appreciate that the tether may take various forms, for example the tether may be formed of a strap made of plastic, nylon, urethane, leather, metal, urethane, or other suitable material. Alternatively, the tether may be formed of rope, paracord, cordage, chain or other suitable means. The tether may be flat, round, coiled, or of other suitable shapes. Further still, the tether may be a retractable, for example, a retractable lanyard, coiled, elastic, and/or otherwise configured to retract. The closed ends may similarly take various forms, for example, molded loops, rings, hooks, crimps and ring terminals may be utilized. The tether ends may also be bonded against itself to form closed loops, for example, nylon cord ends may be welded against the nylon cord to form a welded loop in an otherwise conventional fashion. Regardless of the form, the tether is configured to securely interconnect fastener 35 to harness 33 in order to allow a user to securely attach their handheld device to their person.

In various embodiments, tether 37 has a maximum length when fully extended of approximately 4 feet. One will appreciate that such a length will prevent a handheld device from impacting the ground when the handheld device is secured to a user's clothing or personal item (or to a user's pocket as discussed below), particularly when the user is elevated, for example, while the user is rock climbing, seated on a chair lift, hang gliding, boating, or participating in other activities where the handheld device might be inadvertently dropped, for example, while the user is hiking, biking, skiing, or otherwise moving. Moreover, even if the tethered handheld device is not dropped from a significant height, it will be readily retrievable by the user by simply “pulling the line”, that is, simply retrieving the tethered handheld device by pulling the tether toward themselves. Accordingly, if the handheld device is inadvertently dropped into water, soft snow, or other soft surface into which the handheld device could sink, the user may readily retrieve the handheld device by simply pulling the tether toward themselves.

In various embodiments, fastener 35 is a clip having a jaw 56 movably mounted on a base 58. The base and the jaw are pivotally coupled about an axis in such a way that the jaw can pivot to open and close the clamp. When the clip is in its open position there is room between the base and the jaw to insert a small part of a user's clothing or other personal item, such as a backpack, purse, handbag, duffle, hiking sticks, or other items carried by a user. The base and the jaw may have raised ridges designed to meet and securely pinch therebetween the user's clothing or item. For example, FIG. 1 shows clip 35 in its closed position pinching the fabric of a user's clothing or other item. The base also has a mounting hole through which second end 53 of tether 37 may be attached. One will appreciate that other types of fasteners may be used, for example, clasps, buckles, carabiners, S-clips, cable rings, girth hitches, or other attachments that may be used to releasably engage articles of clothing such as coats, shirts, pants, belts, belt loops, etc., or other personal items.

In operation and use, tether apparatus 30 provides a simple and secure way for a user to connect a handheld device to their clothing or other personal items while maintaining access to all the photographic and other functions of that device, with or without a case.

To use tether apparatus 30, a user would in no particular order perform the following actions: place the central aperture 44 at the rear of their handheld device and then stretch the four corner apertures 40 and corresponding corner loops 42 over the edges of their electronic device so that furthest extended portion of the corner loops wrap around to the front side of the handheld device, as shown in FIG. 1; and using clip 35, attach tether 37 to an item of the user's choosing such as an article of clothing or a backpack.

An exemplary use of tether apparatus 30 is a skier riding a chairlift who wants to place a call, check email, or take several photographs with their smartphone. In this example, the skier is on a chairlift elevated above the surface of the snow such that if they were to drop their smartphone, it would likely be altogether lost to them. And the skier may be using a battery case, encasing their smartphone to extend the life of the smartphone battery. Using the tether apparatus, the skier would be able to remove their smartphone (along with the battery case if used) from their jacket pocket without having to worry about damaging the smartphone, losing the smartphone altogether, and/or causing harm to another person or personal property located below the chair lift. When the skier removes the smartphone from their jacket pocket, the skier would be able to both take photographs using either the front or rear facing camera lenses. In addition, the skier would be able to enjoy full use of the smartphone as well as the protection and extended battery life offered by the protective case while keeping their smartphone secured to their person. And if the skier were to inadvertently drop the smartphone, it could only drop the length of the tether, thus avoiding loss or injury below. To retrieve the smartphone, the skier need only pull on the tether and grab the smartphone.

In various embodiments as shown in FIG. 8, tether apparatus 30a is similar to that described above but includes an overmolded connection 60, a thickened solid region 47a, reinforcing ribs 60, and an alternative fastener 35a in the form of a carabiner style clip.

In various embodiments, tether apparatus 30a may be provided with overmolded connection to permanently attach tether 37a to harness 33a. In such embodiments, the harness may be molded in situ about the first end 51a of tether 37a, as shown in FIG. 9. One will appreciate that such overmolding may facilitate manufacturing by reducing part count and simplifying assembly.

In various embodiments, the solid region 47a is thicker than the remaining web 39a. In such embodiments, the solid region is up to twice as thick, or more, than the remaining web. For example, the solid region may be about 6 mm, 8 mm, 10 mm thick or more. The additional thickness may provide additional structural integrity to the web, particularly if a logo 49a is formed in solid region 47a by sunken relief. One will appreciate that a web with a thicker solid region may be formed by molding, casting, 3D printing, and/or other suitable means.

In various embodiments, one or more ribs 60 may be formed between central opening 44a and corner apertures 40a. The ribs are also thicker than the remaining web 39a, and may be up to twice as thick, or more. Like the thicker solid region above, thicker ribs may also provide additional structural integrity to the web. One will appreciate that a web with thickened ribs may also be formed by molding, casting, 3D printing, and/or other suitable means.

In various embodiments as shown in FIG. 10, tether apparatus 30b is similar to those described above but includes a thickened tab 46b, and an alternative tether 37b in the form of retractable lanyard.

Like the thickened solid region described above, tab 46b can be formed up to twice as thick or more as the remaining web 39b as shown in FIG. 11, or even thicker. Again, the additional thickness may provide additional structural integrity to the web, and particularly the tab to which the tether is attached.

In various embodiments as shown in FIG. 12, tether apparatus 30c is similar to those described above but includes an alternative harness 33c, and an alternative tether 37c in the form of metal chain.

As noted above, the harness and central opening may take various shapes. Similarly, the corner apertures, corner loops, and tab may take various shapes. In various embodiments, corner apertures 40c and corner loops 42c may have a more pointed configuration, the central opening may be wider, and/or the tab 46c may have linear edges.

In various embodiments as shown in FIG. 13, tether apparatus 30d is similar to those described above but includes an alternative harness 33d, and an alternative tether 37d in the form of a cord. As noted above, the web is provided with at least one central opening. In various embodiments, the web 39d may be provided with multiple central openings 44d, 44d′, at least one of which is large enough to provide unobstructed access to and use of a rear-facing camera as discussed above.

In various embodiments as shown in FIG. 14, tether apparatus 30e is similar to those described above but includes an alternative harness 33e and an alternative tether 37e in the form of a roller chain. In various embodiments, and similar to web 39d above, web 39e may be provided with multiple central openings 44e, 44e′, 44e″.

In various embodiments as shown in FIG. 15, tether apparatus 30f is similar to that described above but includes an alternative harness 33f, and an alternative tether 37f in the form of plastic chain. In various embodiments, central opening 44f may be further enlarged and may be symmetric about a horizontal axis.

Turning now to FIG. 16 and FIG. 17, and as noted above, the web is dimensioned and configured to have sufficient stretch or flexibility to allow each corner loop be stretched over a respective corner of the handheld device regardless of whether or not an external case is mounted on the device. As shown in FIG. 16 and FIG. 17, harness 33 is mounted on both handheld device 32′ and its external case 63.

Turning now to FIG. 18 and FIG. 19A, in various embodiments, tether apparatus 30g is similar to that described above but includes an alternative harness 33g and a retractable tether assembly 65 including a retractor housing 67 having a rewind button 68 that is mounted within the harness.

Retractable tether assembly 65 generally includes a spring-loaded spooling mechanism housed within retractor housing 67 that permits tether 37g to be unwound by pulling on the tether, which spooling mechanism automatically locks the unwound tether against retraction onto the spool device, and retracts the tether upon pressing rewind button 68 (see FIG. 18). Such spooling mechanisms are otherwise conventional, functionally similar to widely known badge reels, retractable lifelines, and other known self-winding devices. For example, such spooling mechanisms are functionally similar to that shown in U.S. Pat. No. 1,120,341 to Smith.

As can be seen in FIG. 19A, retractor housing 67 is located within elastomeric harness 33g. The elastomeric harness includes a chamber 70 in which the retractor housing is located, whereby the elastomeric harness encases the retractor housing. The elastomeric harness may also include a tether passage 72 extending downwardly from the chamber to provide access for elongated tether 37g to retract through the elastomeric harness and into the retractor housing. Like the above tether apparatuses, a fastener 35g is connected to a terminal end 53g of the elongated tether 37g, and is configured for releasably engaging an article attached to a user thus allowing the user to easily retrieve the handheld device if dropped.

As shown in FIG. 19A and FIG. 19B, retractable tether assembly 65 may include a tube 74 through which elongated tether 37g extends out from retractor housing 67. The tube may be provided to minimize and/or prevent frictional rubbing between the elongated tether and the inner surface of tether passage 72 of elastomeric harness 33g. The tube may be discrete from the retractor housing, as shown in FIG. 19A and FIG. 19B. One will appreciate, however, that retractor housing 67h and tube 74h may be integrally connected and/or monolithically formed, as shown in FIG. 20A and FIG. 20B.

Like the harnesses described above, elastomeric harness 33g may be formed of various materials suitable for molding, casting, 3D printing, and/or other like means to form the harness about the retractor housing. For example, harness 33g may be formed in situ about the retractor housing 67 such that the retractor housing defines chamber 70 within the formed harness. Forming the harness in situ about the retractor housing creates a monolithic elastomeric harness. As such, the retractor housing may be permanently mounted within the chamber of the elastomeric harness, wherein the only way to remove the retractor housing from the harness is by tearing or otherwise damaging the harness.

One will appreciate that integrally and/or monolithically forming tube 74 with retractor housing 67 may simplify construction, not only by reducing part count, but also by simplifying in situ forming. For example, if the tube and retractor are integral with one another, only one item need be indexed or oriented within a mold cavity during in situ molding.

One will also appreciate that such in situ forming around the retractor housing is well suited for forming elastomeric bodies configured for releasably engaging various handheld devices that a user might carry on their person. One will further appreciate that such elastomeric bodies may include the harnesses, webs and membranes described above, but may also include other elastomeric bodies that are configured to releasably engage smartphones, tablets, and the like.

Turning now to FIG. 20, in various embodiments, tether apparatus 30i is similar to that described above but includes a monolithic harness 33i and tether 37i. Namely, the harness and the tether are monolithically formed of a single piece of material. Like the harnesses described above, the monolithic harness and tether may be formed of various materials that are suitable for molding, casting, 3D printing, and/or other like means.

Like the harnesses described above, tether 37i may similarly be flat. For example, the tether may be of substantially uniform thickness in the range of 0.5 mm to 3.5 mm, preferably in the range of 1.0 to 3.0 mm, and more preferably in the range of 1.5 to 2.5 mm. Alternatively, as shown in FIG. 22A and FIG. 22B, the tether may have protrusions 75 in the form of nubs, ribs or other structure projecting from the uniform thickness in order to vary the overall coefficient of elasticity of the tether.

A first end of 51i of tether 37i is integrally connected to elastomeric body 39i, and a second end 53i of the tether is releasably connected to fastener 35i. In various embodiments, the second end may be formed with a loop 77 that may be used to secure the second end to the fastener with a girth hitch 79 in an otherwise conventional manner. One will appreciate that the material of the tether and the dimensions of the second end loop should be configured to allow the second end loop to stretch sufficiently to allow the harness to pass through the loop.

In various embodiments, tether 37i is retractable having a first retracted length in its relaxed condition, as shown in FIG. 20A, and a second extended length in its pulled condition. For example, the tether may be formed of an elastic material in which a user and/or the weight of the handheld device, may pull second end 53i away from first end 51i (or vice versa) thereby stretching the tether to its extended length, and the elastic memory of the material tends to bias the tether back to its retracted length. In various embodiments, the tether includes a series of interconnected bends 81. One will appreciate that, when second end 53i is pulled away from first end 51i (or vice versa), the series of bends may flex and straighten and thus allow the tether to lengthen.

In various embodiments, as shown in FIG. 21B, fastener 35j may include a hanger 82 configured to receive a portion of harness 33j such that the harness can be hung from the fastener while the fastener is clamped to an article worn or borne by the user, or while clamped to other article such as a tent seam, etc. Such a hanger provides for a convenient storage position when the harness is not attached to an electronic device. With reference to FIG. 21C, the hanger includes a hook or slot extending from clip jaw 56j approximating the thickness of the harness web to readily receive a portion of the web.

Turning now to FIG. 23, an exemplary tether system, generally designated 130, is mounted on a handheld device 132 and secured within a pocket 133. The tether system of the present invention is also particularly suitable for use with the mobile phones, smartphones, and other devices described above.

Generally, and with reference to FIG. 25, tether system 130 includes a harness 135, a pocket 133 provided on an article worn or borne by a user (e.g., jacket 137 in FIG. 23, backpack 137a in FIG. 26, etc.), and a tether 139 releasably securing the harness to the pocket. The harness is configured to stretch over and releasably engage the respective corners of a handheld device, while the tether is configured for releasably engaging a mount 140 secured within the pocket. The tether interconnects the harness and the mount within the pocket, whereby the tether prevents the handheld device from dropping far and allows a user to easily retrieve the handheld device if dropped. Like the harnesses described above, harness 135 is generally formed of an elastomeric membrane or web (see, e.g., web 142d in FIG. 30) including a plurality of corner apertures (see, e.g., apertures 144d in FIG. 30) that each define a corner loop 146 configured to stretch over and engage a respective corner of the handheld device to releasably secure the harness to the handheld device. And like the harnesses described above, harness 135 may include a tab 147, a solid region and/or indicia located between the lower corner loops (see, e.g., solid region 149d and indicia 151d in FIG. 30).

Tether 139 includes a first end 153 connected to harness 135 and a second end 154 releasably connected to mount 140. In various embodiments, the tether is a coiled nylon cord having first and second ends in the form of closed loops that are closed by a crimp 156, however, one will appreciate that the various tethers described above may be utilized. Preferably, the tether is retractable to some degree such that it is self-retracting as a user places the handheld device in their pocket. For example, the coiled tether 139 shown in FIG. 25 is self-coiling to reduce the overall length of the tether as the handheld device is placed in the user's pocket, thus avoiding unnecessary tangling of the tether. Similarly, the elastic-cord tether 139c shown in FIG. 28, and the monolithic tether 139g shown in FIG. 29, will return to their unstretched lengths as the handheld device is placed in the user's pocket. One will appreciate that various other retractable tethers may be utilized in accordance with various aspects of the present invention.

Regardless of the form, the tether is configured to securely interconnect the harness to the mount located within the pocket, thus allowing a user to securely and releasably interconnect the tether system to both their handheld device to their pocket in a manner that allows the user to conveniently secure the handheld device within their pocket while providing the user with ready, yet secured access to the handheld device.

In accordance with various aspects of the present invention, tether 139 includes a fastener 158 to releasably secure second end 154 of tether 139 to mount 140 within pocket 133. In various embodiments, and as shown in FIG. 25, the fastener may be a clip or carabiner having a body 160 and a gate 161. The body and the gate are pivotally coupled in such a way that a user may simply slip the fastener around the mount such that the mount enters the clip through the gate and thus clip the fastener to the mount. One will appreciate that other types of fasteners may be used, for example, clasps, buckles, carabiners, S-clips, cable rings, girth hitches (see, e.g., girth hitch 158g in FIG. 29) or other attachment devices that may be used to releasably engage the tether to the mount within the user's pocket. For example, the fastener may be in the form of a crimped loop at the second end 154 of tether 139, as shown in FIG. 25, or in the form of a buckle 163c as shown in FIG. 28. Such buckles have separable first and second parts, in which the first part is secured to the second end tether 139c, and the second part is secured to mount 140.

As noted above, the pocket-bearing article 137, 137a may be worn or born by a user. In particular, the article may be an article of clothing worn by the user, such as the jacket 137 shown in FIG. 23, or the article may be a personal item 137a carried by the user such as the backpack shown in FIG. 26. One will appreciate that various articles of clothing may be used including, but not limited to, jackets, vests, shirts, pants, shorts, and other suitable articles of clothing worn by a user. Similarly, one will appreciate that various personal items may be used including, but not limited to backpacks, courier bags, hand bags, purses, childcare bags, work bags, briefcases, and other personal items carried by the pocket.

In various embodiments, the pocket may be open. And in various other embodiments, the pocket may be enclosed with zippers, hook fasteners such as Velcro®, snaps, buttons, buckles, magnets and other suitable means. For example, as shown in FIG. 25, pocket 133 may have a zipper 165 that is selectively opened to allow access to the handheld device 132. Alternatively, as shown in FIG. 26, pocket 133a may have a flap 167 that may be selectively opened. One will further appreciate that other pocket configurations may be utilized in accordance with various aspects of the present invention to allow a user ready access to a handheld device stored within.

In the illustrated embodiment of FIG. 25, mount 140 may be a loop having two ends secured to the article 137, within pocket 133. One will appreciate that other mounts may be utilized in accordance with the present invention. For example, a tab may be used to which the fastener may be releasably secured. One will appreciate that other types of mounts may be utilized in accordance with the present invention to provide a suitable anchor within the pocket to which the second end of the tether may be releasable secured.

As also shown in FIG. 25, mount 140 may be secured within pocket 133 along a perimeter (e.g., a seam) remote from the opening. For example, mount 140 may be secured at a corner 168 that is remote from the opening. In various embodiments, the mount is positioned a distance from the opening that is substantially equal to or greater than the overall length of the handheld device. Such configuration may facilitate placement of the handheld device into the pocket as the retractable nature of the tether may reduce or prevent tangles of the tether while the handheld device is placed into the pocket.

In various embodiments, the solid region of web may be modified to receive removable indicia. For example, solid region 149d may be provided with a recessed receptacle 170 into which an object such as a medallion 172 is received, as shown in FIG. 30 and FIG. 31. Such medallions allow customization of the tether system to promote branding and/or other ornamentation. Alternatively, the receptacle may be configured to receive one or more accessories. For example, an LED light, a grip, a stand, tripod, clamp, RFID chip and/or other accessories may be releasably engaged to the harness via the receptacle. For example, an RFID chip 173 may be mounted within the receptacle within, on or below the medallion 172, as shown in FIG. 30 and FIG. 31.

One will appreciate that the solid region may be monolithically formed with the remainder of the web, or may be formed of a second material, such as a stiffer silicone, rubber, neoprene, rubber, latex, urethane, etc., or a more rigid material such as plastic, composite, metal, and/or other suitable material. When a second material is utilized, the web may be 3D printed with two different materials, or the web remainder may be cast about the solid region, overmolded about the solid region, affixed to the solid region by a suitable adhesive or bonding agent, or by other means.

One will appreciate that medallion 172 may be permanently attached to solid region 149d by glue or other suitable means. Alternatively, the medallion may be releasably attached to the solid region. For example, the medallion may be snapped into receptacle 170 in an otherwise conventional fashion.

Alternatively, the medallion may have an insert-and-twist configuration, as shown in FIG. 32 and FIG. 33. For example, receptacle 170e may be provided with one or more lobes 174, and medallion 172e may have recessed areas that allow the medallion to be inserted into the receptacle past the lobes, and then twisted to engage the lobes to releasably lock the medallion in the receptacle. Such an insert-and-twist configuration may be particularly suited to receive a clamp accessory that may be attached to a ski pole or hiking stick to form a selfie stick.

And further still, the medallion may have a slide-in configuration, as shown in FIG. 34 and FIG. 35. For example, receptacle 170f may be provided with a shoulder 175 partially extending around the receptacle. The medallion may slide in through the open side of the receptacle and under the shoulder such that the medallion is releasably engaged within the receptacle. One will appreciate that other receptacle and medallion configurations may be utilized to affix indicia and other ornamentation to the thickened region. Also, such a slide-in configuration may be particularly suited to receive a clamp accessory that may be attached to a ski pole or hiking stick to form a selfie stick.

With reference to FIG. 23 and FIG. 26, in operation and use, tether system 130 provides a simple and secure way for a user to connect a handheld device to their clothing or other personal items while maintaining access to all the photographic functions of that device with or without a case. Tether system 130 is used in a manner similar to the tether apparatuses described above, with the primary difference being the second end 154 of tether 139 is secured to mount 140 within pocket 133 of the user's article (see, e.g., FIG. 25), such as an article of clothing 137 (e.g., FIG. 23) or a personal item 137a (e.g., FIG. 26).

In many respects, various modified features of the various figures resemble those of preceding features and the same reference numerals followed by subscripts “a”, “b”, “c”, “d”, “e”, “f”, “g”, “h”, “i”, “j” and “k” designate corresponding parts.

For convenience in explanation and accurate definition in the appended claims, the terms “downwardly”, “lower”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A tether apparatus for securing a handheld device to a user, the handheld device having a plurality of corners, the tether apparatus comprising:
a harness including an elastomeric body configured to engage the plurality of corners of the handheld device thereby releasably securing the elastomeric body to the handheld device;
a fastener configured for releasably engaging an article worn or borne by a user; and
an elongated tether interconnecting the fastener and the harness, a first end of the tether connected to the elastomeric body, and a second end of the tether connected to the fastener;
wherein the elastomeric body and the elongated tether are monolithically formed; and
wherein the elongated tether allows a user to easily retrieve the handheld device if dropped while the fastener is engaged with the article of the user.

2. (canceled)

3. A tether apparatus according to claim 1, wherein the elastomeric body includes a plurality of corner apertures, each defining a corner loop configured to stretch over and engage a respective corner of the handheld device thereby releasably securing the harness to the handheld device.

4. A tether apparatus according to claim 1, wherein the elastomeric body includes a solid region having a receptacle receiving a medallion therein, the medallion having ornamental indicia.

5-6. (canceled)

7. A tether apparatus according to claim 1, wherein the tether is retractable having a first retracted length in a retracted mode, and a second extended length in an extended mode, wherein the second extended length is configured to prevent the handheld device from dropping to the ground when the fastener is secured to the article of the user.

8. A tether apparatus according to claim 7, wherein the tether includes a plurality of bends, wherein the bends flex and straighten when the tether is pulled.

9. A tether apparatus according to claim 1, wherein the tether is flat.

10-11. (canceled)

12. A tether apparatus according to claim 1, wherein the personal electronic device includes a centrally-located rear-facing camera, and wherein the central opening is configured to provide unobstructed access to the rear-facing camera while the harness is secured to the personal electronic device.

13. A tether apparatus according to claim 1, wherein the elastomeric body includes a plurality of corner apertures, each defining a corner loop configured to stretch over and engage a respective corner of the handheld device thereby releasably securing the harness to the handheld device, the elastomeric body further including a central opening, wherein the plurality of corner apertures have a maximum aperture dimension and the central opening has a maximum opening dimension, and wherein the maximum opening dimension is larger than the maximum aperture dimension.

14. A tether apparatus according to claim 1, wherein the elastomeric body includes a plurality of corner apertures in the body, each defining a corner loop configured to stretch over and engage a respective corner of the handheld device thereby releasably securing the harness to the handheld device; and a central opening, wherein a centroid of the body is located within the central opening.

15. A tether apparatus according to claim 1, wherein the elastomeric body includes a plurality of corner apertures, each defining a corner loop configured to stretch over and engage a respective corner of the handheld device thereby releasably securing the harness to the handheld device, and wherein the elongated tether is retractably received within a retractor housing, the retractor housing being located within the elastomeric body, and wherein the fastener is connected to a terminal end of the elongated tether, wherein the elongated tether allows a user to easily retrieve the handheld device if dropped while the fastener is engaged with the article of the user.

16. (canceled)

17. A tether apparatus according to claim 1, the tether apparatus further comprising an article configured to be worn or borne by a user, the article including a pocket having an interior accessed by an opening, the pocket including a mount secured to the article within the interior of the pocket at a position remote from the opening, wherein the elongated tether is retractable and interconnects the harness and the mount, a first end of the tether being connected to the harness, and a second end of the tether connected to the mount.

18. A tether apparatus according to claim 17, wherein the pocket includes a perimeter, and the mount is secured to the article along the perimeter remote from the opening.

19. A tether apparatus according to claim 18, wherein the perimeter includes a corner remote from the opening, wherein the mount is secured to the article at the corner.

20. (canceled)

21. A tether apparatus for securing a handheld device to a user, the handheld device having a plurality of corners, the tether apparatus comprising:
a harness including an elastomeric web, the web including a plurality of corner apertures, each defining a corner loop configured to stretch over and engage a respective corner of the handheld device thereby releasably securing the harness to the handheld device, the web further including a central opening, wherein the plurality of corner apertures have a maximum aperture dimension and the central opening has a maximum opening dimension, and wherein the maximum opening dimension is larger than the maximum aperture dimension;
a fastener configured for releasably engaging an article attached to the user; and
an elongated tether interconnecting the fastener and the harness, a first end of the tether being connected to the harness, and a second end of the tether connected to the fastener,
wherein the tether allows a user to easily retrieve the handheld device if dropped while the fastener is engaged with the article of the user.

22-23. (canceled)

24. A tether apparatus according to claim 21, wherein the central opening is asymmetric.

25. (canceled)

26. A tether apparatus according to claim 21, wherein the first end of the tether is permanently attached to the harness.

27. A tether apparatus according to claim 21, further comprising a retractable tether assembly having a retractor housing, wherein the harness includes a chamber encasing the retractor housing, wherein the harness is monolithically formed about the retractor housing.

28-32. (canceled)

33. A tether system for securing a handheld device to a user, the handheld device having a plurality of corners, the tether system comprising:
a harness including a web configured to releasably engage the handheld device, the web including a plurality of corner apertures, each defining a corner loop configured to stretch over and engage a respective corner of the handheld device thereby releasably securing the harness to the handheld device;
an article configured to be worn or borne by a user, the article including a pocket having an interior accessed by an opening, the pocket further comprising a mount secured to the article within the interior of the pocket at a position remote from the opening; and
a retractable tether interconnecting the harness and the mount, a first end of the tether being connected to the harness, and a second end of the tether connected to the mount.

34-35. (canceled)

36. A tether system according to claim 33, wherein the opening is defined by a zipper.

37-38. (canceled)

39. A tether system according to claim 33, wherein the tether includes a cord having a coiled section extending intermediate the first and second ends of the tether.
